(19) United States
(12) Patent Application Publication
(10) Pub. No.: US 2025/0303660 A1
(43) Pub. Date: Oct. 2, 2025

(54) MANUFACTURING CONTINUOUS BELT OF TYRE BASE LAYER

(71) Applicant: RETYRE AS, North Follo (NO)

(72) Inventors: Paul Magne Amundsen, Oslo (NO); Sigmund Andenes, Oslo (NO); Tarjei Aure Hofset, Oslo (NO); Olaf Brage Marvik, Oslo (NO); Sven-Erik Markhaus Kaiser, Oslo (NO)

(21) Appl. No.: 18/864,481

(22) PCT Filed: May 12, 2023
(86) PCT No.: PCT/EP2023/062847

§ 371 Date: Nov. 8, 2024

(30) Foreign Application Priority Data
May 12, 2022 (NO) 20220564
May 12, 2022 (NO) 20220565
May 12, 2022 (NO) 20220566

(51) Int. Cl. B29D 30/70; B29K 705/00

(52) U.S. Cl. CPC B29D 30/70; B29K 2705/00

(57) ABSTRACT

A method of manufacturing a continuous belt of tyre base layer, the method comprising providing a sheet of material having a first lateral edge portion, and a second lateral edge portion, wherein the first lateral edge portion is separated from the second lateral edge portion by a central portion, laying a first stiffening element on the sheet where the first lateral edge portion and central portion meet, and laying a second stiffening element on the sheet where the central portion and second lateral edge portion meet, folding the first lateral edge portion over the first stiffening element, folding the second lateral edge portion over the second stiffening element, and securing the first lateral edge portion and the second lateral edge portion to the central portion.

### TECHNICAL FIELD

The present invention relates to methods and apparatus for manufacturing a continuous belt of tyre base layer, and to the resulting continuous belt of tyre base layer. The present invention may further extend to methods and apparatus for manufacturing a tyre through use of the continuous belt of tyre base layer.

### BACKGROUND

Tyres (e.g. tyres for vehicles which may be any apparatus for transporting people or cargo) are typically manufactured using a batch process requiring manual labour during intervening steps of the process, as well as during a number of steps of the process itself. For example, bead wires are typically formed into loops for use in the tyre in an initial step, placed by hand onto a loop of tyre base layer material on a drum, and the bead wires then secured within the tyre base layer. A pre-formed strip of rubber to form the tread may then be placed onto the tyre base layer whilst on the drum. The combined loop of tread and tyre base layer is moved to an expanding mold where a curve is added to the flat surface of the loop. The partially shaped tyre may then be placed by hand into individual curing molds for further shaping the tyre and forming the tread pattern during the curing process.

Such batch processes are inefficient in time and cost. It would therefore be beneficial to enable a manufacturing process for tyres with increased efficiency.

### SUMMARY OF THE INVENTION

Viewed from a first aspect, the invention provides a method of manufacturing a continuous belt of tyre base layer, the method comprising: providing a sheet of material having a first lateral edge portion, and a second lateral edge portion, wherein the first lateral edge portion is separated from the second lateral edge portion by a central portion, laying a first stiffening element on the sheet where the first lateral edge portion and central portion meet, and laying a second stiffening element on the sheet where the central portion and second lateral edge portion meet, folding the first lateral edge portion over the first stiffening element, folding the second lateral edge portion over the second stiffening element, and securing the first lateral edge portion and the second lateral edge portion to the central portion.

A tyre base layer is a layer provided beneath the tread of the tyre and which provides a framework to the tyre. In pneumatic tyres where an inner tube or inner liner is present, the base layer covers the inner tube or inner liner to provide protection and to constrain the inner tube or inner liner thereby supporting resistance to internal pressure. The tyre base layer may comprise a fibre composite. The fibres of the fibre composite may be referred to as a carcass for a tyre.

A stiffening element is any feature that provides a stiffening effect to the tyre base layer. The stiffening element therefore aids in giving rigidity to the tyre base layer, therefore aiding the tyre base layer's ability to maintain its shape and withstand internal pressure. The sheet of material of the tyre base layer may be a flexible material to provide toughness to the base layer and assisting the tyre to grip a surface when in use. The sheet of material may be a sheet of fabric, or a sheet of elastomer, or a sheet of composite material. The sheet of fabric may comprise a mesh, i.e the sheet may have an open structure resulting from separation of the fibres of the mesh fabric sheet. The stiffening element may be in the form of a bead wire. A bead wire is a length of material akin to a cable or rod in that it extends substantiality in one dimension. When the bead wire is laid on the sheet of material, the bead wire extends in one direction and does not form a loop. A bead wire is not necessarily limited to a metal wire.

The method enables a base layer comprising a stiffening element to be formed in a continuous process. The base layer comprising a stiffening element may be formed in a flat piece which need not be provided with a length commensurate with the circumference of a tyre. Instead using the above method, a long length of base layer can be produced with a length many times the circumference of a tyre which can cut to an appropriate size on demand. Providing a continuous belt of base layer allows the base layer to be incorporated into a continuous process for forming a tyre.

The sheet may comprise a longitudinal length, and the first lateral edge portion and central portion meet along a line parallel to the longitudinal length of the sheet, and the central portion and second lateral edge portion meet along a line parallel to the longitudinal length of the sheet.

Thus, the width of the portion of material folded over the stiffening elements remains constant along the longitudinal length of the base layer. A longitudinal length of each of the stiffening elements is thus provided parallel to the longitudinal length of the base layer.

When a bead wire is used as the stiffening element the bead wire will extend in and be parallel to the longitudinal length of the base layer. The stiffening elements will maintain the same distance from the edge of the base layer along the entire length of the base layer. Thus, when used within a tyre, each of the stiffening elements will meet coherently with other ends of stiffening elements when two ends of base layer are joined.

The sheet of material can comprise any suitable material for use in a base layer of a tyre. For example, a plastic or a metal. The sheet of any such material may be provided in a mesh form comprising through surface holes, or in continuous/plate form comprising no through surface holes, i.e. continuous material.

Following the folding of the first lateral edge portion over the first stiffening element and following the folding of the second lateral edge portion over the second stiffening element, the first lateral edge portion and the second lateral edge portion may overlap, and the method may comprise: securing the first lateral edge portion to the second lateral edge portion.

If the widths of material folded over the stiffening portions is large enough, it will be possible to bond the overlapped area of the first and second lateral edge portions. The base layer can therefore be constructed with increased strength, in particular increased tensile strength in the lateral direction. Additionally, the overlapped portions will form additional layers of material through the thickness of the base layer, improving the base layer's properties such as strength, toughness, damage and puncture resistance.

The stiffening element may be a bead wire comprising a metal, or a thermoplastic polymer, or a thermoset polymer.

The bead wire may comprise Kevlar or another suitable aramid material. The bead wire may comprise steel, aluminium or another suitable metal or metal alloy.

The first and/or second stiffening element may be secured to the sheet of material.

The first and/or second stiffening elements are therefore bonded to the sheet of material so that they cannot easily move from their secured position. In the case that the sheet of material comprises a component which can act as heat activated adhesive component (such as a suitable elastomer), the material may be heated in order to fix the beads in position. The first and/or second stiffening element may be secured to the sheet of material by sewing the stiffening element to the sheet of material. Optionally the thread for sewing the stiffening element to the sheet of material is a nylon thread, an UHMW polyethylene thread or an aramid thread. Sewing the first and/or second stiffening element to the sheet of material may be particularly advantageous in the case that the sheet of material comprise a fabric and/or a mesh fabric.

By securing the stiffening element to the sheet of material, the stiffening element is held in position more effectively.

When securing the first and/or second stiffening element to the sheet of material is performed before the first and/or second lateral end portions are folded over the stiffening elements, the dimensional accuracy of the folding procedure is increased.

The sheet of material may comprise fibre and optionally one or more of an elastomer and an adhesive.

The fibres may comprise any suitable material such as one or more of nylon, cotton, polyester, aramid, and semi-synthetic fibres such as rayon yarn. The fibres may be provided in a mesh structure in order to form a fabric sheet with an open structure, i.e. a structure comprising through surface holes.

In the case that the sheet comprises fibre and one or more of an elastomer and an adhesive, the sheet of material will hence comprise a fibre composite. The adhesive may be an epoxy. The fibres of the fibre composite used in tyre base layers may be referred to as a carcass. The fibres may comprise one or more of nylon, cotton, polyester and aramid. The elastomer may comprise rubber, or a thermoplastic elastomer, or a thermoset elastomer The elastomer may be in the form of a coating on the fibres. For example, the sheet of material may comprise nylon fibres and a rubber coating, or, nylon fibres and a thermoplastic elastomer.

The fibre composite provides high strength and toughness, in particular the fibres have a high tensile strength.

In some use of the language a tyre base layer comprising a fibre composite may be referred to as carcass for a tyre, in this case the method of the present invention may extend to manufacturing a continuous belt of carcass for a tyre. The sheet of material may comprise fibres disposed in a weave pattern or a knitted pattern, and wherein the longitudinal length of the fibres in the weave pattern is mis-aligned with the longitudinal direction of the sheet of material.

The weave or knitted pattern comprises fibres extending in different directions and arranged so that fibres overlap one another and/or weave above and below each other. The weave and/or knitted pattern may comprise a first set of uni-directional fibres and one or more second sets of fibres for securing the first set of fibres relative to one another. The sheet of material may be formed via a biaxial weave or a tri-axial weave. The sheet of material may comprise a thread count of 5 T (Total fibres per square inch) or higher. The sheet material may comprise a thread count of 50 T or higher.

The weave and knitted pattern can produce mesh (open) structures comprising through surface holes or continuous structures comprising no through surface holes. Oxford fabric is an example of a continuous structure comprising no through holes formed by weaving.

The fibre composite tyre base layer sheet material may begin as an initial sheet having two widths of similar magnitude and at least some of the fibres may extend parallel to a width of the sheet. To create a length of base layer sheet material in which the longitudinal length of the fibres is misaligned with the longitudinal direction of the sheet of material, the base layer sheet material is cut from the initial sheet at a desired angle relative to the width of the initial sheet. By utilizing fibres misaligned to the length of the base layer, and consequently misaligned to the circumferential length of a tyre formed with the base layer, the high tensile strength of the fibres is able to provide strength in multiple directions of the tyre.

The woven or knitted material may be coated with an elastomer. In particular, oxford fabric may be coated with thermoplastic polyurethane and used as the sheet of material for the tyre base layer.

The longitudinal length of the fibres may be mis-aligned with the longitudinal direction of the sheet of material by 30 degrees or more.

Optionally, the fibres may be mis-aligned with the longitudinal direction of the sheet of material by 45 degrees. Misaligning the fibres to a high degree allows a more even distribution of strength across the directions of the tyre.

The securing may comprise welding the overlapped material together using a welding or may comprise a sewing operation.

The welding operation may provide increased strength to the join between the overlapping portions. The welding operation may comprise one or more of heated tool welding, hot gas welding, ultrasonic welding, spin welding, infrared welding, high frequency welding, vibration welding, induction welding, microwave welding, resistant welding, extrusion welding, and laser welding.

The welding operation may comprise applying heat and pressure, optionally wherein the temperature of the material is raised to above 140 degrees centigrade. This softens the material and provides adhesion when cooling down. The heat may be applied from an external heat source, and/or the heat may be generated by mechanical movement, and/or the heat may be generated using electromagnetism.

The sewing operation may comprise securing the overlapped material to one another with a thread. The sewing operation is particularly advantageous when the sheet of material comprises a fabric and/or a mesh fabric.

The securing may comprise adding a bonding material to at least a portion of the overlapped portions of the sheet of material.

Optionally, the bonding material may be an adhesive such as a self-curing adhesive, reactive adhesive pressure-sensitive adhesive, thermosetting adhesive. The bonding material may be a resin or an epoxy. The sheet of material may comprise an elastomer coating, and during a heat treatment the elastomer coating may act as a bonding material. The elastomer coating may comprise a rubber or thermoplastic elastomer.

Improvement of the securing process can be achieved via surface modification prior to bonding, such as through a plasma pretreatment or corona pretreatment applied to at least a portion of the overlapped portions of the sheet of material. Such pretreatment for example cleans the surface and/or activates the surface for improved bonding. Such surface modification can be carried out in combination with bonding a fabric sheet to a fabric sheet, a composite sheet to a composite sheet, an elastomer sheet to elastomer sheet and in the case that a bonding material is added to at least a portion of the overlapped portions the sheet being any of fabric, composite or elastomer. A plasma or corona treatment is particularly advantageous in cases where the sheet of material is comprised of fabric and/or a mesh fabric.

The method comprises providing a puncture protection layer on at least part of the central portion of the sheet of material.

The puncture protection material being positioned on the central portion ensures that when the base layer is used for a tyre, the puncture protection layer will be positioned correctly to protect the tyre. The puncture protection material may extend along the length of the sheet of material and central portion thereof. The puncture protection layer may be provided on at least a centre region of the central portion so that when a tyre is formed using the base layer, the puncture protection layer will be positioned beneath the tread and thus beneath where the tyre contacts the road for optimum protection.

The puncture protection layer may be provided on at least part of the first lateral edge portion and/or second lateral edge portion of the sheet of material. Therefore, once the first and second lateral portions are folded over, the puncture protection layer will be appropriately positioned for use in a tyre providing reinforcement to the ground contacting part of the tyre as well as the side walls of the tyre which are also at risk of punctures.

The puncture protection layer may comprise one or more of elastomer, plastic, composite, fibre sheet, fibre reinforced elastomer, and metal.

The material of the puncture protection layer is tough and resistant to penetration or damage via objects. The puncture protection layer may comprise rubber or another suitable elastomer.

The puncture protection layer may be provided on either or both sides of the sheet of material relative to the side enveloped by the first and second lateral edge portions once each is folded onto the central portion.

The puncture protection layer may be in place on the sheet of material as the folding of the first and second lateral edge portions is carried out, alternatively the puncture protection layer can be overmolded onto the sheet of material after the securing of the first lateral edge portion and the second lateral edge portion to the central portion has been carried out.

The method may comprise spooling the continuous belt of tyre base layer onto a reel.

The continuous belt of base layer may be spooled on a reel, particularly in order to store the base layer before it is cut to a desired length for use in a tyre.

Viewed from another aspect, the invention provides a method of manufacturing a continuous belt of tyre base layer, the method comprising: providing a tubular material having a longitudinal length, inserting a first stiffening element and a second stiffening element into the tubular material such that a longitudinal length of each stiffening element is parallel with the longitudinal length of the tubular material, affixing the first and second stiffening elements to opposite first and second longitudinal sides of the tubular material.

A tubular material has a hollow cross section which extends along its length. The tubular material may have a circular hollow cross section; however the tubular material may be flexible so that the cross section shape is changeable.

A stiffening element is any feature that provides a stiffening effect to the tyre base layer. The stiffening element therefore aids in giving rigidity to the tyre base layer, therefore aiding the tyre base layer's ability to maintain its shape and withstand internal pressure. The sheet of material of the tyre base layer may be a flexible material to provide toughness to the base layer and assisting the tyre to grip a surface when in use. The stiffening element may be in the form of a bead wire. A bead wire is a length of material akin to a cable or rod in that it extends substantiality in one dimension. When the bead wire is laid on the sheet of material, the bead wire extends in one direction and does not form a loop. A bead wire is not necessarily limited to a metal wire.

The stiffening elements are affixed opposite one another such that the length of material between the two stiffening elements is the same above and below the stiffening elements when viewed in cross section perpendicular to the length of the tubular material.

The method enables a base layer comprising a stiffening element to be formed in a continuous process. The base layer comprising a stiffening element may be formed in a flat piece which need not be provided with a length commensurate with the circumference of a tyre. Instead using the above method, a long length of base layer can be produced with a length many times the circumference of a tyre which can cut to an appropriate size on demand. Providing a continuous belt of base layer allows the base layer to be incorporated into a continuous process for forming a tyre.

Providing the tubular material may comprise providing a sheet of material having a first edge portion and a second edge portion opposite the first edge portion; and securing the first edge portion to the second edge portion to form a tube.

The first and second stiffening elements may be introduced into the tubular material as the first and second edge portions are being secured together.

The stiffening elements may thus be fed into position simultaneously as the tubular material is being formed.

The securing of the first edge portion to the second edge portion of the sheet of material may comprise sewing the first edge portion to the second edge portion.

The securing of the first edge portion to the second edge portion of the tubular material may comprise welding the overlapped material together using a welding operation.

The welding operation may comprise one or more of heated tool welding, hot gas welding, ultrasonic welding, spin welding, infrared welding, high frequency welding, vibration welding, induction welding, microwave welding, resistant welding, extrusion welding, and laser welding. The welding operation may comprise applying heat and pressure to the overlapped material. The heat may be applied from an external heat source, and/or the heat may be generated by mechanical movement, and/or the heat may be generated using electromagnetism.

The securing of the first edge portion to the second edge portion of the tubular material may comprise adding a bonding material to the sheet of material.

Optionally the bonding material may be an adhesive such as a self-curing adhesive, reactive adhesive pressure-sensitive adhesive, thermosetting adhesive. The bonding material may be a resin or an epoxy. The tubular material may comprise an elastomer coating which during a heat treatment the elastomer coating may act as a bonding material.

The tubular material between and above the first and second stiffening elements may be bonded to tubular material between and below the first and second stiffening elements.

Thus, a flat length of base layer is formed comprising bead wires embedded in the base layer.

The bonding of the relevant portions of tubular material may comprise welding overlapping tubular material together using a welding operation.

The welding operation may comprise one or more of heated tool welding, hot gas welding, ultrasonic welding, spin welding, infrared welding, high frequency welding, vibration welding, induction welding, microwave welding, resistant welding, extrusion welding, and laser welding. The welding operation may comprise applying heat and pressure to the overlapping tubular material. The heat may be applied from an external heat source, and/or the heat may be generated by mechanical movement, and/or the heat may be generated using electromagnetism.

The tubular material may comprise fibre and one or more of an elastomer and an epoxy. Thus, the tubular material may comprise a fibre composite. The fibres of the fibre composite used in tyre base layers may be referred to as a carcass. The fibres may comprise any suitable material such as nylon, cotton, polyester and aramid. The elastomer maybe a thermoplastic elastomer, a thermoset elastomer or a rubber. The elastomer may be in the form of a coating on the fibres. For example, the sheet of material may comprise nylon fibres and a rubber coating, or the sheet of material may comprise nylon fibres and a thermoplastic elastomer.

The fibre composite provides high strength and toughness, in particular the fibres have a high tensile strength.

The tubular material may comprise fibres disposed in a weave pattern, and wherein the weave pattern is mis-aligned with the longitudinal length of the tubular material.

The weave and or knitted pattern may comprise a first set of uni-directional fibres and one or more second sets of fibres for securing the first set of fibres relative to one another. The sheet of material may be formed via a biaxial weave or a tri-axial weave. The sheet of material may comprise a thread count of 5 T (Total fibres per square inch) or higher. The sheet material may comprise a thread count of 50 T or higher.

The fibre composite base layer sheet material may begin as an initial sheet having two widths of similar magnitude and at least some of the fibres may extend parallel to a width of the sheet. To create a length of base layer sheet material in which the longitudinal length of the fibres is misaligned with the longitudinal direction of the sheet of material, the base layer sheet material is cut from the initial sheet at a desired angle relative to a width of the initial sheet before the first and second side portions are secured to one another to form the tubular material.

By utilizing fibres misaligned to the length of the base layer, and consequently misaligned to the circumferential length of a tyre formed with the base layer, the high tensile strength of the fibres is able to provide strength in multiple directions of the tyre.

The longitudinal length of the fibres may be mis-aligned with the longitudinal direction of the tubular material by at least 30 degrees. Optionally the fibres may be mis-aligned with the longitudinal direction of the sheet of material by 45 degrees.

Optionally the fibres may be mis-aligned with the longitudinal direction of the sheet of material by 45 degrees. Misaligning the fibres to a high degree allows a more even distribution of strength across the directions of the tyre.

The method may comprise providing a puncture protection layer on at least part of the overlapping portion of tubular material.

The puncture protection material being positioned on the overlapping portion of tubular material ensures that when the base layer is used for a tyre, the puncture protection layer will be positioned correctly to protect the tyre. The puncture protection material extends along the length of the tubular material and overlapping portion thereof.

The puncture protection layer may be provided on at least a centre region of the overlapping portion so that when a tyre is formed using the base layer, the puncture protection layer will be positioned beneath the tread and thus beneath where the tyre contacts the road for optimum protection.

The puncture protection layer may comprise one or more of elastomer, plastic, composite, fibre sheet, fibre reinforced elastomer.

The material of the puncture protection layer is tough and resistant to penetration or damage via objects. The puncture protection layer may comprise rubber or another suitable elastomer.

The puncture protection layer may be provided on the radially outer side of the tubular material as viewed in cross section perpendicular to the longitudinal length of the tubular material and/or the puncture protection layer is provided on the radially inner side of the tubular material as viewed in cross section perpendicular to the longitudinal length of the tubular material

The puncture protection layer may be inserted into the tubular material as the first and second edge portions are secured together. Alternatively, the puncture protection layer can be overmolded onto the tubular material after the affixing of the first and second stiffening elements to opposite first and second longitudinal sides of the tubular material has been carried. The puncture protection layer and/or stiffening elements may be fed into position simultaneously as the tubular material is being formed.

The method of either of the aspects described above may comprise: providing a continuous belt of tyre base layer according to the method of any preceding claim, and cutting the belt of tyre base layer to a length suitable for use within a single tyre.

The belt may be cut to a size that is commensurate with the circumference of a single tyre. The belt may be cut to a size that is a fraction of the circumference of a single tyre.

The method may comprise applying heat to the tyre base layer and stretching the tyre base layer over the surface of a wheel, causing the tyre base layer to adopt a curvature.

The heat allows the tyre base layer to become malleable in order to be plastically deformed as it is stretched over the wheel. The tyre base layer is allowed to cool such that the curvature adopted as the tyre base layer is stretched over the wheel is maintained by the tyre base layer.

Stretching the tyre base layer over the wheel may be done in a continuous process so that the continuous belt of tyre base layer is fed over the wheel and removed from the wheel without cutting the tyre base layer.

Shaping the tyre base layer may reduce the complexity and/or increase the efficiency of further processes to form a tyre with the tyre base layer.

The tyre base layer may be stretched over the surface of the wheel so as to adopt a double curved tyre shape. The double curve tyre shape comprises a curvature having a radius of curvature r in a lateral cross section and a curvature having a radius of curvature R in a cross section perpendicular to the longitudinal cross section of the cylindrical tyre. The tyre base layer will then have a shape corresponding to that of a tyre.

The method may comprise: inserting a length of the continuous belt of tyre base layer into a cavity of a tyre base layer mould; applying heat and pressure to the length of tyre base layer within the tyre base layer mould such that length of the continuous belt of tyre base layer adopts the shape of the cavity of the tyre base layer mould, wherein the shape of the cavity of the tyre base layer mould comprises at least one segment of a cylindrical tyre having at least one curvature, wherein the arc of the segment extends along a longitudinal length of the cavity.

The tyre base layer is thus modified to comprise a shape corresponding to that of a tyre.

Although the molding process will take place over discrete lengths of tyre base layer, tyre base layer may be fed into and out of the tyre base layer mold in a continuous manner such that after molding, the tyre base layer at an aft end of the tyre base layer mold is pulled through to a forward end of the tyre base layer mold and the molding process repeated in order to shape subsequent tyre base layer along the length of the belt of tyre base layer.

Alternatively, the belt of tyre base layer may be cut to a desired length prior to entering the tyre base layer mold.

The shape of the cavity of the tyre base layer mold may correspond to a segment of a circle. The segment may be a 45 degree segment or less, may be a 45 degree segment or more, a 90 degree segment or more, may be a 180 degree segment (i.e. a semicircle) or more, may be a 270 degree segment or more.

The segment of a cylindrical tyre may comprise a double curve such that the tyre has a radius r in a lateral cross section and a radius of curvature R in a cross section perpendicular to the longitudinal direction of the cylindrical tyre.

The base layer will then have a shape corresponding to that of a tyre.

The shape of the cavity of the tyre base layer mold may comprise a plurality of segments of a cylindrical tyre. The arc of each of the plurality of segments may extend along the longitudinal length of the cavity and the midpoints of at least one pair of adjacent segments may extend in the same transverse direction relative to the longitudinal length of the cavity, thereby forming a bump-like pattern.

Additionally or alternatively, the arc of each of the plurality of segments may extends along the longitudinal length of the cavity and the midpoints of at least one pair of adjacent segments extend in opposite transverse directions relative to the longitudinal length of the cavity, thereby forming a sine wave-like pattern. The mold therefore reduces the dimensions and complexity of the mold by flattening the mold in respect of the curve with radius R in a cross section perpendicular to the longitudinal direction of the cylindrical tyre.

By separating a tyre's full circumference into segments and arranging these segments along a length of the tyre base layer mold, a simplified linear arrangement for the molding apparatus and process can be provided compared to molding an entire tyre circumference at once. This may contribute to an efficient continuous process for the shaping of tyre base layers.

The tyre base layer mold may be a substantially flat mold comprising a housing comprising at least one longitudinal inner cavity extending between at least two opposing main walls and two opposing edge walls, wherein: each of the main walls has at least one elevation and at least one depression; each elevation and each depression extends and slopes in both a lateral and a longitudinal direction of the cavity; the elevations and depressions are arranged alternately along the length of the tyre base layer mold; and an elevation of one main wall is opposite a depression of the other main wall.

The substantially flat mold therefore reduces the dimensions and complexity of the mold by flattening the mold in respect of the curve with radius r in the lateral cross section as well as the curve with radius R in a cross section perpendicular to the longitudinal direction of the cylindrical tyre.

Viewed from another aspect, the invention provides a continuous belt of tyre base layer manufactured according to the method of any preceding claim.

By continuous belt it is meant that the length of the tyre base layer is not provided as discrete lengths for a single tyre, but instead the base layer comprising the stiffening elements is provided in a form that can be used in a continuous process, or a form that can be cut down to desired lengths.

Viewed from another aspect, the invention provides a method of manufacturing a tyre base layer and tread element, the method comprising: providing a continuous belt of tyre base layer according to a method described above; inserting a length of the tyre base layer into a tread mold; injecting an elastomeric material into the tread mold; allowing the elastomeric material to set in order that the elastomeric material and tyre base layer adopt the shape of the tread mold; and removing the bonded tyre base layer and elastomeric material from the tread mold.

The tyre base layer and tread element may be formed in the form of a continuous belt of tyre base layer and tread element by entraining further tyre base layer of the continuous belt of base layer into the tread mold as the bonded tyre base layer and elastomeric material is removed from the tread mold. A continuous tread may be formed on the continuous belt of tyre base layer by aligning the end of the previously formed tread to the relevant end of the mold as the tyre base layer is entrained and repositioned in the tread mold. Alternatively the tread may be formed discontinuously along the continuous belt of tyre base layer so that there is a gap between adjacent lengths of tread.

The setting of the elastomeric material may cause the bonding of the elastomeric material to the tyre base layer. Alternatively, an additional bonding material may be used between the elastomeric material and the tyre base layer. The hardening and/or cooling of the elastomeric material allows the shape of the mold to be maintained in the elastomeric material and the tyre base layer.

The surface of the base layer to be bonded to the tread may undergo a pretreatment prior to the overmolding of the elastomeric material. The pretreatment may be a plasma treatement or a corona treatment. The pretreatment may modify the surface such that an improvement in the strength and reliability of the bond can be achieved. The pretreatment for example cleans the surface and/or activates the surface for improved bonding.

The shape of a cavity of the tread mould may comprise at least one segment of a cylindrical tyre comprising at least one radius of curvature.

The shape of the cavity of the tread mold may correspond to a segment of a circle. The segment may be a 45 degree segment or less, may be a 45 degree segment or more, a 90 degree segment or more, may be a 180 degree segment (i.e. a semicircle) or more, may be a 270 degree segment or more.

The continuous belt of tyre base layer may be provided with having been pre-shaped as described above and the radius of curvature adopted by the tyre base layer may be larger than the radius of curvature of cavity of the tread mould.

Thus when a tyre base layer mold and a tread mold are used, the radius of curvature of the at least one segment of the tyre base layer mould is greater than the radius of curvature of the at least one segment of the tread mould. That is to say, the transverse and longitudinal extents of the at least one segment in the tyre base layer mould are greater than the transverse and longitudinal extents of the at least one segments in the tread mold. Therefore, the at least one segment of the tyre base layer preform has larger dimensions than the at least one segment of the tread mould into which it is inserted.

Due to the difference in thermal expansions of the material of the tyre base layer and the thermal expansion of the tread material, following the deposition of the tread onto the base layer and subsequent cooling the curvature of the base layer and tread will align. Thus differences in thermal expansion of different materials is accounted for.

The continuous belt of tyre base layer may be provided with a substantially flat shape according to the method described above, wherein the dimensions of the depressions and elevations of the tyre base layer mold are greater than the dimensions of the depressions and elevations of the tread mould.

Thus, when a substantially flat tyre base layer mold and a substantially flat tread mold are used, the dimensions differ between the molds such that the dimensions of the shaped tyre base layer are larger than the equivalent dimensions of the shaped tread. Due to the difference in thermal expansions of the material of the tyre base layer and the thermal expansion of the tread material, following the deposition of the tread onto the base layer and subsequent cooling the curvature of the base layer and tread will align. Thus, differences in thermal expansion of different materials is accounted for.

Viewed from another aspect, the invention provides a method of manufacturing a tyre; the method comprising: providing at least one length of tyre base layer and tread element according the method described above, joining the ends of the at least one length of tyre base layer and tread element to form a complete loop.

The complete circular tyre may be formed from a single length of tyre base layer and tread element so that one longitudinal end is joined to the other longitudinal end, or alternatively multiple tyre base layer and tread elements may be joined at respective longitudinal ends to form a loop. In this way various sized tyres can be made from a continuous belt of tyre base layer and tread element, or from discrete tyre base layer and tread elements.

Viewed from another aspect, the invention provides an apparatus for manufacturing a continuous belt of tyre base layer, the apparatus comprising: a tyre base layer material spool for storing a sheet of material; one or more stiffening element spools for storing stiffening elements; an assembly unit for receiving material from the tyre base layer material spool and first and second stiffening elements from the one or more stiffening element spools, and for assembling the continuous tyre base layer, wherein the assembly unit comprises a folding apparatus for folding a first edge portion of the sheet of material over the first stiffening element and for folding a second edge portion over the second stiffening element.

The folding apparatus may comprise securing means for securing the first and second edge portions to a central portion of the sheet of material.

The securing unit may comprise a welding apparatus. The welding apparatus may be suitable for performing one or more of heated tool welding, hot gas welding, ultrasonic welding, spin welding, infrared welding, high frequency welding, vibration welding, induction welding, microwave welding, resistant welding, extrusion welding, and laser welding. The heat may be applied from an external heat source, and/or the heat may be generated by mechanical movement, and/or the heat may be generated using electromagnetism.

The securing unit comprises a heat gun for applying hot air to the sheet of material. Optionally, wherein the heat gun is configured to raise the temperature of the carcass material to above 140 degrees centigrade.

The apparatus may comprise a spool for storing puncture protection material and means for feeding the puncture protection material to the assembly unit.

The folding apparatus may comprise a sewing machine for sewing the first and second stiffening elements into their respective positions on the sheet of material.

### BRIEF DESCRIPTION OF THE DRAWINGS

Certain embodiments of the invention will now be described by way of example only and with reference to the accompanying drawings in which:

FIG. 1 shows a sheet of tyre base layer material and stiffening elements, the sheet and stiffening elements may continue in length beyond the dimensions indicated in the figure

FIG. 2a shows a tyre base layer comprising stiffening elements

FIG. 2b shows a tyre base layer comprising stiffening elements

FIG. 3a shows an apparatus for forming a tyre base layer comprising stiffening elements

FIG. 3b shows an apparatus for providing components for forming a tyre base layer comprising stiffening elements

FIG. 3c shows a spool onto which a belt of continuous tyre base layer comprising stiffening elements is rolled

FIG. 4 shows a sheet of tyre base layer material and stiffening elements, the sheet and stiffening elements may continue in length beyond the dimensions indicated in the figure

FIG. 5 shows a tyre base layer comprising stiffening elements

FIG. 6a shows a cross section through the longitudinal length of a continuous belt of tyre base layer comprising stiffening elements

FIG. 6b shows a cross section through the longitudinal length of a continuous belt of tyre base layer comprising stiffening elements

FIG. 7a shows a cross section through the longitudinal length of a continuous belt of tyre base layer comprising stiffening elements and a puncture protection layer

FIG. 7b shows a cross section through the longitudinal length of a continuous belt of tyre base layer comprising stiffening elements and a puncture protection layer

FIG. 7c shows a cross section through the longitudinal length of a continuous belt of tyre base layer comprising stiffening elements and a puncture protection layer

FIG. 8 shows an apparatus for providing a puncture protection layer for forming a continuous belt of tyre base layer comprising stiffening elements and a puncture protection layer

FIG. 9 shows a tubular material and stiffening elements for forming a tyre base layer, the tubular material and stiffening elements may continue in length beyond the dimensions indicated in the figure

FIG. 10 shows a tyre base layer comprising stiffening elements comprising a tubular material, the tyre base layer comprising stiffening elements may continue in length beyond the dimensions indicated in the figure

FIG. 11 shows a cross section through the longitudinal length of a continuous belt of tyre base layer comprising stiffening elements

FIG. 12a shows a cross section through the longitudinal length of a continuous belt of tyre base layer comprising stiffening elements and a puncture protection layer

FIG. 12b shows a cross section through the longitudinal length of a continuous belt of tyre base layer comprising stiffening elements and a puncture protection layer

FIG. 12c shows a cross section through the longitudinal length of a continuous belt of tyre base layer comprising stiffening elements and a puncture protection layer

FIG. 13 shows a tyre base layer comprising stiffening elements shaped as a segment of a double curved tyre shape

FIG. 14 shows an apparatus for shaping the tyre base layer and stiffening elements

FIG. 15 shows a segment mold for shaping the tyre base layer and stiffening elements

FIG. 16 shows a segment of a tyre base layer and stiffening element shaped using the segment mold of FIG. 15

FIG. 17 shows a segment mold for shaping the tyre base layer and stiffening elements

FIG. 18 shows a cross section through the longitudinally extending centre line of a substantially flat mold for shaping the tyre base layer comprising stiffening elements

FIG. 19 shows the lower half of a substantially flat mold for shaping the tyre base layer comprising stiffening elements

FIG. 20 shows a contour map of the substantially flat shape

FIG. 21 shows a tyre base layer comprising stiffening elements comprising the substantially flat shape

FIG. 22 shows a tyre base layer comprising stiffening elements and an overmolded tread

FIG. 23 shows an apparatus for manufacturing a continuous belt of tyre base layer comprising stiffening elements and overmolded tread

FIG. 24 shows a cross section through the longitudinally extending centre line of a substantially flat mold for overmolding tread to a tyre base layer comprising stiffening elements

FIG. 25 shows a tyre base layer comprising stiffening elements comprising an overmolded tread and comprising the substantially flat shape

FIG. 26 shows a segment mold for overmolding a tread to a tyre base layer comprising stiffening elements

FIG. 27 shows a tyre base layer comprising stiffening elements comprising an overmolded tread, comprising a double curved tyre shape and formed using the mold of FIG. 26

FIG. 28 shows a segment mold for overmolding a tread to a tyre base layer comprising stiffening elements

FIG. 29 shows a tyre base layer comprising stiffening elements comprising an overmolded tread, comprising a double curved tyre shape and formed using the mold of FIG. 28

FIG. 30 shows a substantially flat tread mold and a pre-shaped tyre base layer comprising stiffening elements

FIG. 31 shows two lengths of tyre base layer comprising stiffening elements

FIG. 32 shows two lengths of tyre base layer comprising stiffening elements each comprising a double curved shape

FIG. 33 shows a complete loop of tyre base layer formed by joining the ends of a single strip tyre base layer comprising stiffening elements

FIG. 34 shows a complete loop of tyre base layer formed by joining multiple strips of tyre base layer comprising stiffening elements

FIG. 35 shows a contact region between two lengths of tyre base layer

FIG. 36 shows a contact region between two lengths of tyre base layer

FIG. 37 shows the end portions of two lengths of tyre base layer

FIG. 38 shows the contact region between the two lengths of tyre base layer shown in FIG. 37, and a piece indicating the overmolded material to be added to the partly overlapped end portions

FIGS. 39a to 39d show plan views of configurations for the end portions of the lengths of the tyre base layer

FIGS. 40a to 40c show transverse views of two lengths of tyre base layer joined using an insert

FIG. 41a shows a lateral view of two lengths of tyre base layer joined using an insert, shown in expanded form

FIGS. 41b and 41c show a plan view of two lengths of tyre base layer joined using an insert

FIG. 42a shows a lateral view of two flat lengths of tyre base layer joined and comprising a liner material

FIG. 42b shows two lengths of tyre base layer comprising a double curved shape joined and comprising a liner material

FIG. 42c shows an expanded view of FIG. 42b

FIG. 43 shows two lengths of tyre base layers to be joined comprising fibres, and a liner material comprising fibres

FIG. 44a shows two lengths of tyre base layers comprising stiffening elements and a tread to be joined

FIG. 44b shows two lengths of tyre base layer comprising stiffening elements and a tread to be joined

FIG. 45 shows an apparatus for joining a first and second length of tyre base layer comprising stiffening elements together.

### DETAILED DESCRIPTION

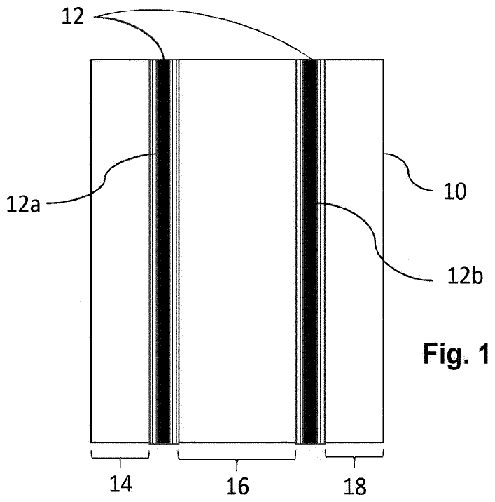

As seen in FIG. 1, a pair of bead wires 12 are positioned onto a sheet of base layer material 10 and each are aligned with the longitudinal length of the sheet 10. The sheet 10 thus comprises a first lateral edge portion 14, a central portion 16 and a second lateral edge portion 18 delimited by the bead wires 12.

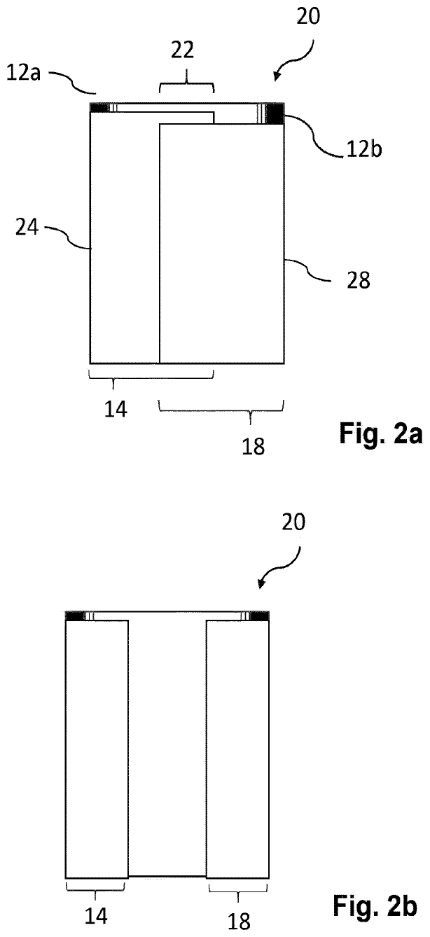

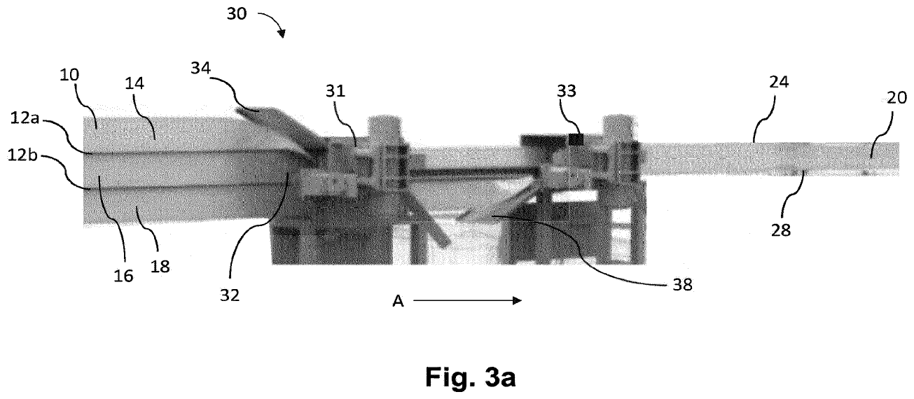

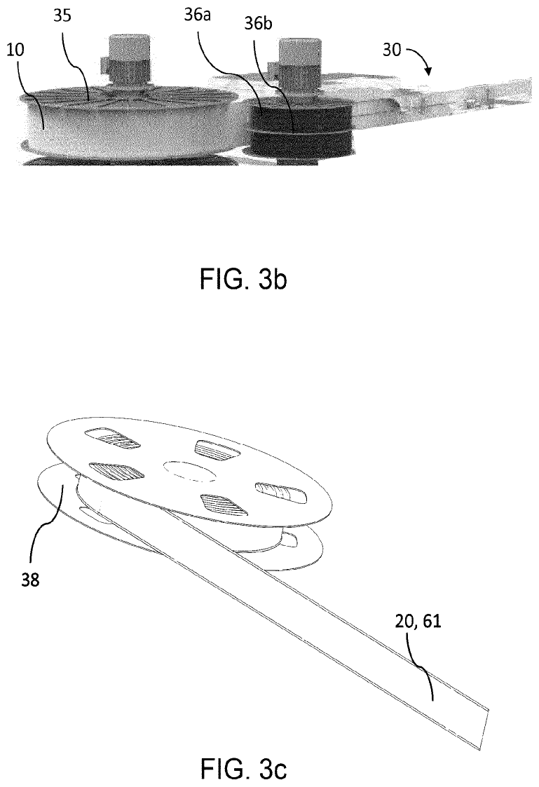

FIG. 2a shows the sheet of tyre base layer material having been formed in to a tyre base layer comprising stiffening elements by folding the first lateral edge portion 14 over the first bead wire 12a and the second lateral edge portion 18 over the second bead wire 12b. The first lateral edge portion 14 and the second lateral edge portion 18 overlap to form an overlapped area 22. The first and second lateral edge portions 14, 18 can be secured to the central portion 16. In the overlapped area 22 the first and second lateral edge portions 14, 18 can also be secured to each other. Since the pair of bead wires 12 are positioned parallel to one another, the first longitudinal side 24 and the second longitudinal side 28 of the tyre base layer comprising stiffening elements 20 are also parallel to one another. The first lateral edge portion 14 and the second lateral edge portion 18 need not overlap to form an overlapped area 22; FIG. 2b illustrates an example in which the first and second lateral edge portions 14, 18 are secured to the central portion only. FIG. 3a shows the folding of the sheet of base layer material 10 being carried out by a folding apparatus 30. The relevant reference numerals as provided in FIGS. 1 and 2 have been reproduced in FIG. 3a. A sheet of base layer material 20 is fed into the folding apparatus 30 at a first end 32 and is moved along the folding apparatus 30 in direction A. A first folding device 31 comprises a first folding guide 34. The first folding guide 34 urges the first lateral edge portion 14 to bend, or fold, around the first bead wire 12a and guides the first lateral edge portion 14 into position adjacent or in contact with the central portion 16. Further along the folding apparatus 30, in direction A, a second folding device 33 is provided. The second folding device 33 comprises a second folding guide 38 which urges the second lateral edge portion 18 to bend, or fold, around the second bead wire 12b and guides the second lateral edge portion 18 into position adjacent or in contact with the central portion 16, and/or adjacent or in contact with the first lateral edge portion 14 in an overlapped area 22.

As the sheet of base layer material 20 is fed through the folding apparatus 30, the creation of the tyre base layer comprising stiffening elements 20 can be performed continuously. In this way, a continuous belt of tyre base layer can be formed. This means tyre base layer comprising stiffening elements 20 sufficient for use is multiple tyres can be formed without manual intervention. The tyre base layer comprising stiffening elements 20 that exits the second folding device 33 can be rolled onto a spool for storage.

The first folding device 31 also comprises a securing means, not shown, in order to secure the first lateral edge portion 14 to the central portion 16. Likewise, the second folding device 33 comprises a securing means, not shown, to secure the second lateral edge portion 18 to the central portion 16 and/or first lateral edge portion 14. For example, the securing means of the first and/or second folding device 31, 33 may comprise a heat gun.

FIG. 3b shows a base layer material spool 35, a first bead wire spool 36a and a second bead wire spool 36b. A sheet of base layer material 10 is fed directly from the base layer material spool 35 to an assembly unit comprising the folding apparatus 30. Likewise first and second bead wires 12a and 12b are fed directly from the first and second bead wire spools 36a, 36b respectively to the folding apparatus 30. A fixing device, not shown, can be used to secure the bead wires 12a, 12b in position on the sheet of base layer material prior to the folding operation beginning.

FIG. 3c shows an assembled tyre base layer comprising stiffening elements 20, 61 being rolled onto a spool 38 for storage. The tyre base layer comprising stiffening elements 20 may be rolled on to the spool 38 directly from the folding apparatus 30 or after further manufacturing steps such as the application of an overmolded as described below. The tyre base layer comprising stiffening elements 61 formed using a tubular material, described further below, can also be rolled onto a spool 38 directly after it is assembled, or after further manufacturing steps also.

The continuous belt of tyre base layer comprising stiffening elements 20 can be drawn from the spool and cut into lengths desirable for further processing for use in a tyre. The continuous belt of tyre base layer comprising stiffening elements 20 can be drawn directly from the spool into a further device for processing the continuous belt of tyre base layer comprising stiffening elements 20 for use in a tyre. In this way the processing can remain continuous.

The continuous belt of tyre base layer comprising stiffening elements 20 can instead be fed directly from the folding apparatus 30 to a further device for processing the continuous belt of tyre base layer comprising stiffening elements 20 for use in a tyre. Similarly, in this way the processing can remain continuous.

FIG. 4 shows the sheet of material 10 comprising a fibre structure. The fibres of the fibre structure may be formed of nylon, cotton, polyester, or aramid. The fibre structure comprises a unidirectional set of fibres 40 (the diagonal hatching indicating the presence and direction of the first set of fibres), wherein each fibre in the set 40 extends in a direction approximately parallel the other fibres in the set 40. The unidirectional set of fibres 40 are supported by a support set of fibres, not shown, that are weaved through the unidirectional set of fibres 40 to secure the fibres relative to one another.

The sheet of material 10 is cut such that the direction of the unidirectional set of fibres 40 is misaligned by an angle a to the longitudinal direction of the sheet.

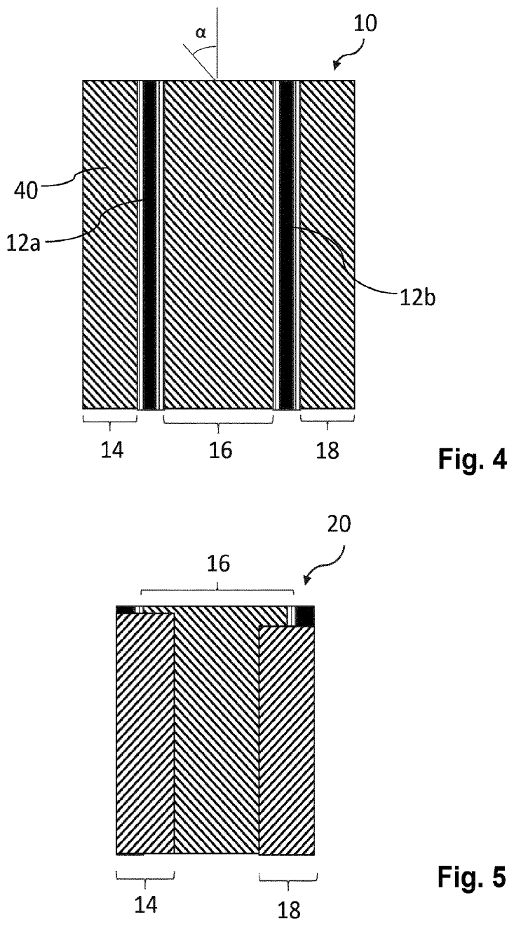

FIG. 5 shows the tyre base layer comprising stiffening elements 20 once the first lateral edge portion 14 is folded over the first bead wire 12a and the second lateral edge portion 16 is folded over the second bead wire 12b. As illustrated by the hatching, the direction of the unidirectional set of fibres 40 in the central potion 16 will differ from the direction of the unidirectional set of fibres in the first and second lateral edge portions. Put another way, the base layer material provided between the pair of bead wires 12 in the tyre base layer comprising stiffening elements 20 will comprise fibres of differing directions.

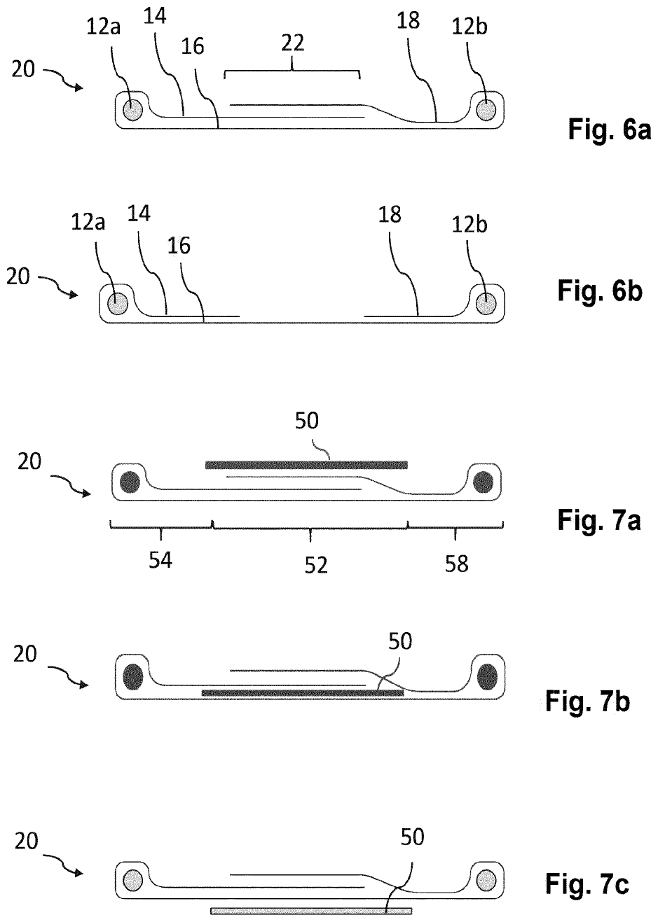

FIG. 6a shows a cross section of the tyre base layer comprising stiffening elements 20 taken perpendicular to its longitudinal length. The first lateral edge portion 14 is folded around the first bead wire 12a and secured to the central portion 16. The second lateral edge portion is folded around the second bead wire 12b and secured to the central portion 16 as well as the first lateral portion 14 in the over lapped area 22.

FIG. 6b shows a similar cross section to FIG. 6a for the example in which the first and second lateral ends 14, 18 do not form an overlapped area 22.

FIGS. 7a to 7c similarly show a cross section of the tyre base layer comprising stiffening elements 20 taken perpendicular to its longitudinal length. Each of FIGS. 7a to 7c show a puncture protection layer 50. In each case the puncture protection layer 50 is provided at a middle portion 52 of the tyre base layer comprising stiffening elements 20. When the tyre base layer is used within a tyre, the middle portion 52 of the tyre base layer comprising stiffening elements 20 will coincide with the tread of the tyre, and the first and second side portions 54, 58 of the tyre base layer comprising stiffening elements 20 will coincide with the side walls of the tyre. The middle portion 52 will be positioned adjacent the ground contacting area of the tyre. The puncture protection layer 50 is thus positioned to at least coincide with the tread of a tyre to provide the most useful protection.

FIG. 7a illustrates the puncture protection layer 50 being provided on an outer surface of the first and/or second lateral portions 14, 18.

FIG. 7b illustrates the puncture protection layer 50 being provided between the central portion 16 and the first and/or second lateral portions 14, 18.

FIG. 7c illustrates the puncture protection layer 50 being provided on an outer surface of the central portion 16.

The puncture protection layer 50 can be provided in corresponding positions as in FIGS. 7a-7c for the example in which the first and second lateral ends 14, 18 do not form an overlapped area 22 as in FIG. 6b.

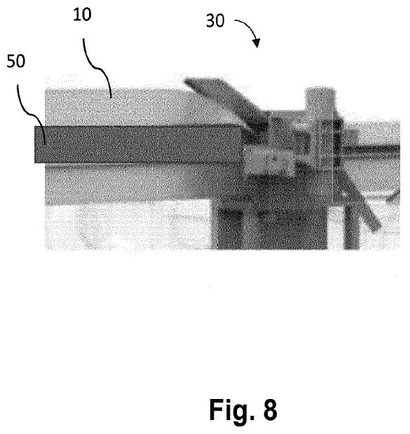

FIG. 8 shows the puncture protection layer 50 being provided to the folding apparatus 30. In this example, the puncture protection layer can be incorporated between an overlapped portion of the sheet of base layer material, or secured to the sheet 10 using the steps described herein.

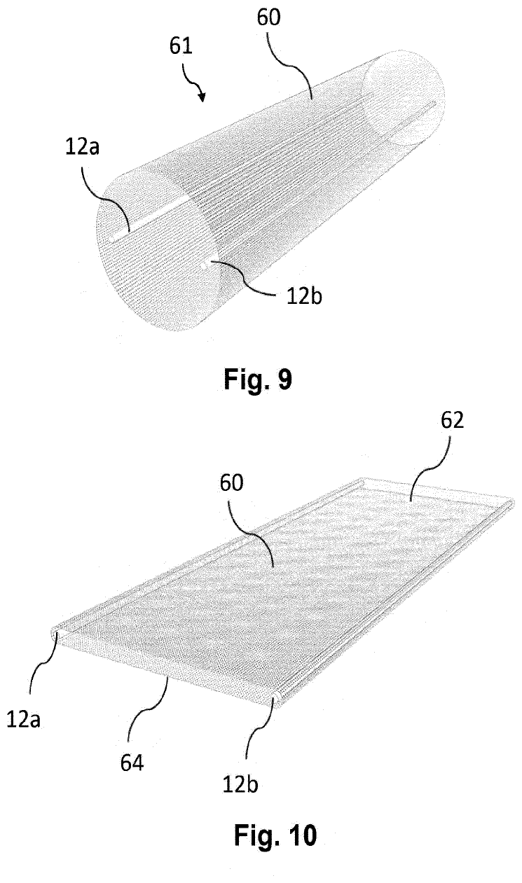

FIG. 9 shows a tubular material 60 used for manufacturing a continuous belt of tyre base layer. The tubular material 60 extends in a longitudinal direction and during manufacturing of the continuous belt of tyre base layer, first and second stiffening elements 12a, 12b are inserted into the tubular material 60 so as to extend in the same longitudinal direction. The first and second stiffening elements 12a, 12b therefore extend parallel to the longitudinal length of the tubular material 60. By tubular it is meant that the material provides a cylinder comprising a hollow centre, thus the stiffening elements 12a, 12b are inserted into the hollow centre. The tube configuration of the tubular material may be created at the same time as the stiffening elements are inserted into the centre of the tubular material (such as by securing a first longitudinally extending edge portion to a second longitudinally extending edge portion or by weaving the material) so as to enable continuous production of the tyre base layer comprising stiffening elements 61.

FIG. 10 shows the tubular material once flattened. To maintain the flattened shape, the tubular material on a first side 62 of (e.g. above) the first and second stiffening elements 12a, 12b is secured to the tubular material on a second side 64 (e.g. below) the first and second stiffening elements. The first side 62 and second side 64 are on opposite sides of the stiffening elements 12a, 12b.

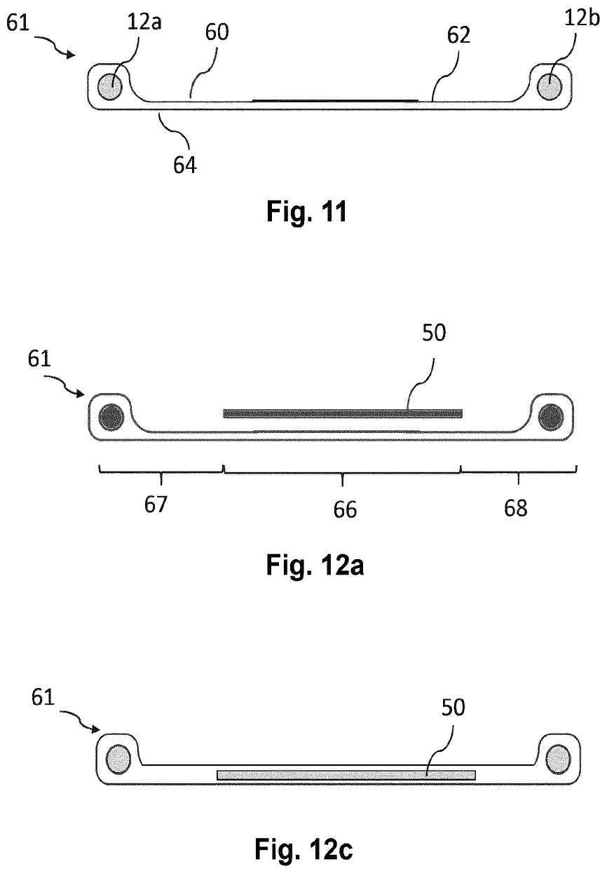

FIG. 11 shows a cross section of the tyre base layer comprising stiffening elements 61 taken perpendicular to its longitudinal length. The tubular material on a first side 62 of (e.g. above) the first and second stiffening elements 12a, 12b is secured to the tubular material on a second side 64 (e.g. below) the first and second stiffening elements.

FIGS. 12a and 12b similarly show a cross section of the tyre base layer comprising stiffening elements 61 taken perpendicular to its longitudinal length. Each of FIGS. 12a and 12b show a puncture protection layer 50. In each case the puncture protection layer 50 is provided at a middle portion 66 of the tubular tyre base layer comprising stiffening elements 61. When the tyre base layer is used within a tyre, the middle portion 66 of the tyre base layer comprising stiffening elements 61 will coincide with the tread of the tyre, and first and second side portions 67, 68 of the tyre base layer comprising stiffening elements 61 will coincide with the side walls of the tyre. The middle portion 66 will be positioned adjacent the ground contacting area of the tyre. The puncture protection layer 50 is thus positioned to at least coincide with the tread of a tyre to provide the most useful protection.

FIG. 12a illustrates the puncture protection layer 50 disposed on the radially outer side of the tubular material 60 as viewed in cross section perpendicular to the longitudinal length of the tubular material. The puncture protection layer 50 can be secured to the belt of tyre base layer in a continuous manner. In a later step, tread may be applied such that the puncture protection layer is between the tread and the tyre base layer, or tread may be applied such that the tyre base layer is between the puncture protection layer 50 and the tread.

FIG. 12b illustrates the puncture protection layer 50 disposed radially inner side of the tubular material as viewed in cross section perpendicular to the longitudinal length of the tubular material. The puncture protection layer can be inserted into the hollow of the tubular material as the tube configuration is created (such as by securing a first longitudinally extending edge portion to a second longitudinally extending edge portion or by weaving the material) so as to enable continuous production of the tyre base layer comprising stiffening elements 20 and puncture protection layer.

The creation of the tyre base layer comprising stiffening elements 61 can be performed continuously. In this way, a continuous belt of tyre base layer can be formed. This means tyre base layer comprising stiffening elements 61 sufficient for use is multiple tyres can be formed without manual intervention. The tyre base layer comprising stiffening elements 61 can be rolled onto a spool for storage. The continuous belt of tyre base layer comprising stiffening elements 61 can be drawn from the spool and cut into lengths desirable for further processing for use in a tyre. The continuous belt of tyre base layer comprising stiffening elements 61 can be drawn directly from the spool into a further device for processing the continuous belt of tyre base layer comprising stiffening elements 61 for use in a tyre. In this way the processing can remain continuous.

In some examples the continuous belt of tyre base layer preform is further processed in order to alter the shape of the tyre base layer comprising stiffening elements 20, 61. The shape is modified to more closely match the shape the tyre base layer will have when it is used within a tyre.

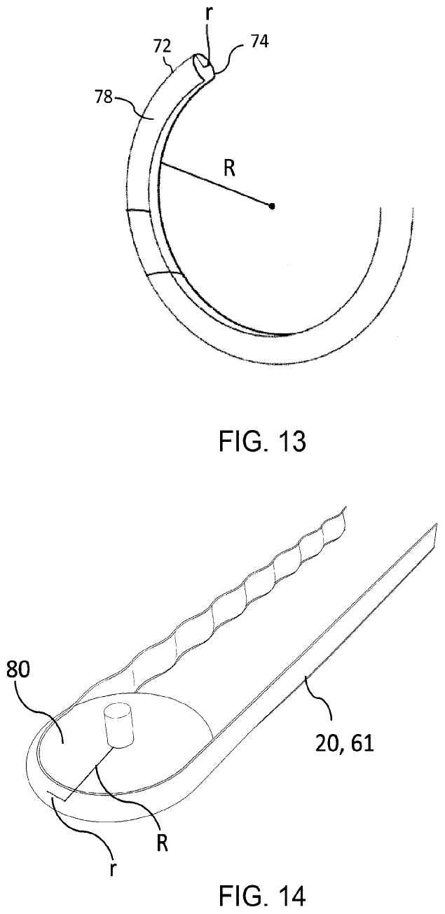

The modified shape will therefore have at least some curved aspect reflecting the double curved tyre shape shown in FIG. 13. The double curve tyre shape comprises a curvature having a radius of curvature r in a lateral cross section and a curvature having a radius of curvature R in a cross section perpendicular to the longitudinal cross section of the cylindrical tyre. The double curved tyre shape can also be described as an annular segment having an omega “Ω” cross section.

The tyre base layer having a double curved shape will comprise a first side wall 74 comprising the first side portion of the tyre base layer 54, 67 and a second side wall 78 comprising the second side portion of the tyre base layer 58, 68. The side walls 74, 78 extend approximately radially and circumferentially about radius of curvature R. The middle portion of the base layer 52, 66 will form an approximately circumferentially and axially extending middle wall 72 about radius of curvature R.

The dimensions of the curvature of the tyre base layer need not match the dimensions of the curvature of the tyre and/or the curvature that the base layer will adopt in the final tyre. The curvature provided to the tyre base layer comprising stiffening elements 20, 61 may be smaller than that of the final curvature in order to introduce a degree of the shaping prior to assembly into a tyre, or the curvature provided to the tyre base layer comprising the stiffening elements may be larger than the final curvature in order to compensate for shrinkage that may occur in further processing to assemble the tyre.

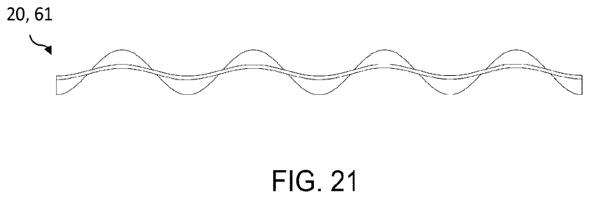

A wheel 80 can be used to shape the tyre base layer comprising stiffening elements 20, 61. The tyre base layer comprising stiffening elements 20, 61 is stretched over the surface of the wheel 80 and heat is applied causing the tyre base layer comprising stiffening elements 20, 61 to adopt a curvature. As shown in FIG. 14 the surface of the wheel 80 has a radius of curvature r in a lateral cross section and a radius of curvature R in a cross section perpendicular to the lateral cross section, thus the tyre base layer comprising stiffening elements 20, 61 stretched over this wheel adopts a double curved tyre shape. The resultingly shaped tyre base layer comprising stiffening elements 20, 61 can be manipulated into a substantially flat shape for ease of further use by inverting portions of the tyre base layer comprising stiffening elements 20, 61 to create depressions and elevations in the longitudinal and transverse direction such as those that can be seen in FIG. 21.

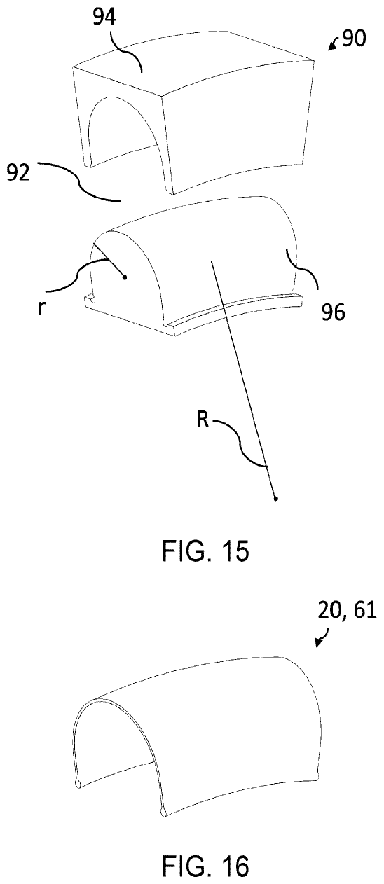

The tyre base layer comprising stiffening elements 20, 61 can be shaped into a double curve tyre shape using a segment mold 90 which comprises a cavity 92 comprising at least a segment of the double curved tyre shape. Such a segment mold 90 is shown in FIG. 15. Tyre base layer comprising stiffening elements 20, 61 can be provided as a belt of continuous tyre base layer and drawn into the cavity 92, the upper and lower parts 94, 96 of the segment mold close in order to compress the tyre base layer comprising stiffening elements 20, 61 within the cavity 92 and heat and pressure is applied.

The shaped tyre base layer that is obtained following shaping using this segment mold 90 is shown in FIG. 16. The cavity 92 and the shaped tyre base layer has a curvature r in the transverse cross section and a radius R in a cross section perpendicular to the transverse cross section.

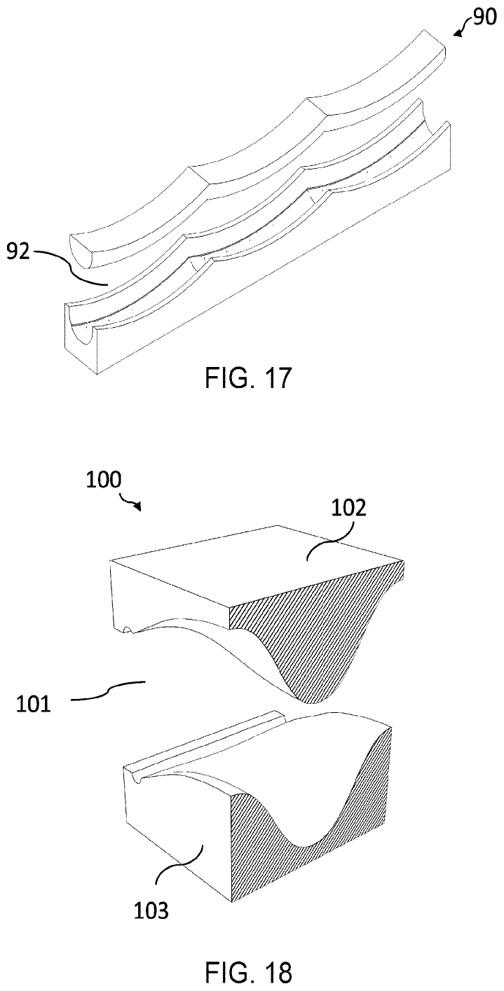

An alternative segment mold 90 is shown in FIG. 17 wherein the cavity 92 comprises a plurality of segments. The shaped tyre base layer comprising stiffening elements resulting from this mold can be further manipulated (e.g. bent or stretched) in order to remove joins between segments and to form a continuous curvature.

FIG. 18 shows a cross section (cut through the centre of the mould) of a substantially flat tyre base layer mold 100 used for pre-shaping the tyre base layer comprising the stiffening elements 20, 61. The cavity 101 created between the top piece 102 and the bottom piece 103 comprises depressions and elevations which extend in a transverse direction of the cavity 101 and a longitudinal direction of the cavity 101.

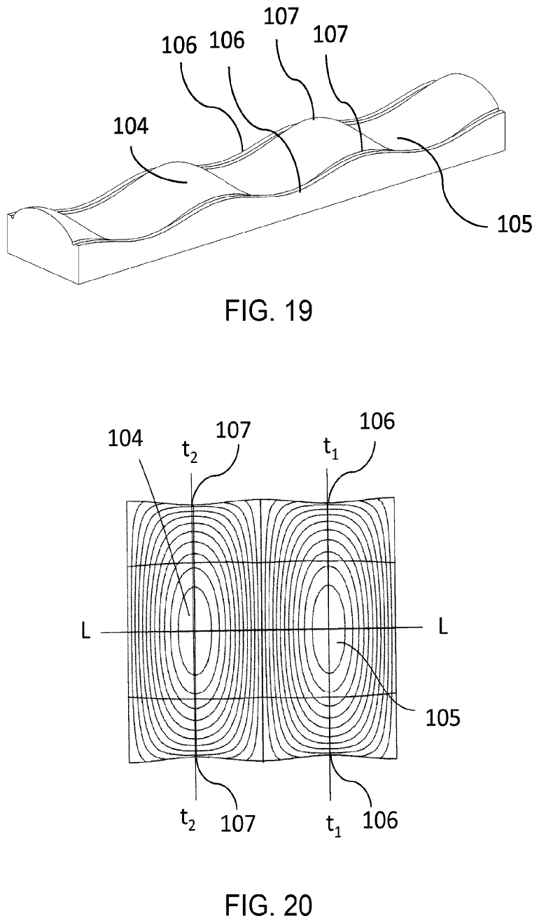

FIG. 19 shows the bottom piece 103 of the substantially flat tyre base layer mold 100 having a plurality of depressions and elevations.

FIG. 20 shows a contour map of the depressions and elevations along the substantially flat tyre base layer mold 100. The elevations and depressions in the longitudinal direction of the cavity of the substantially flat tyre base layer mold are shown along line L-L; 104 indicates a peak and 105 indicates a trough. A depression in the lateral direction is shown along Line t₁-t₁; a high point 106 decreases to a trough 105 and then increases to another high point 106. An elevation in the lateral direction is shown along line t₂-t₂; a low point 107 increases to a peak 104 and then decreases back to a low point 107.

Once the tyre base layer comprising stiffening elements is removed from the substantially flat tyre base layer mold 100, the depressions are reversed, that is inverted, in order that the tyre base layer comprising stiffening elements follows a single curvature in the longitudinal direction of the tyre base layer comprising stiffening elements. The curvatures provided by the depressions and elevations thus sum to form a segment of a circle once the depressions are inverted. Likewise, the depressions and elevations in the lateral direction now adopt complementary curvature to form the side walls of the segment of the circle and form the “Ω” shaped cross section.

Put another way, the curvature adopted by the tyre base layer comprising stiffening elements 20, 61 in the lateral direction assists in the formation of the side walls of the base layer within the tyre, and hence the “Ω” cross section. The curvature adopted by the tyre base layer comprising stiffening elements 20, 61 in the longitudinal direction of the base layer assists in the formation of the tyre annular loop.

FIG. 21 shows the tyre base layer comprising stiffening elements 20, 61 pre-shaped to comprise a substantially flat shape comprising depressions and elevations in the longitudinal and transverse direction.

In some examples, the substantially flat shaped tyre base layer comprising stiffening elements is stored having said form and may later be used in further processes to form a tyre. In some examples, the substantially flat shaped tyre base layer comprising stiffening elements is directly used in further processes to form a tyre and the inversion of the depressions and elevations takes place following subsequent processing steps.

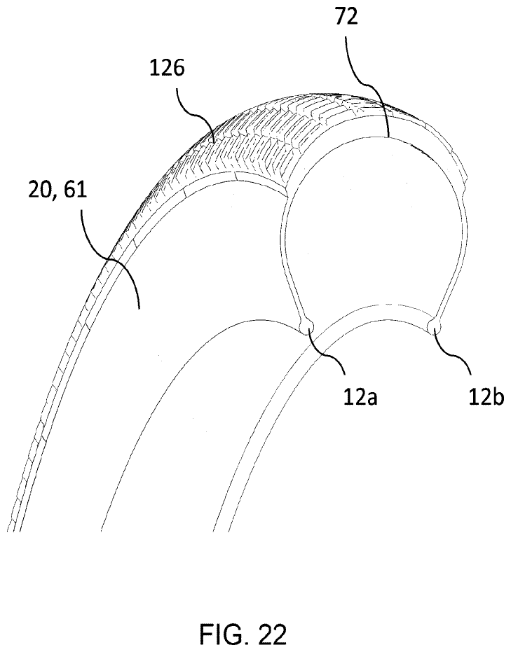

FIG. 22 shows a cross section of a tyre comprising a base layer formed from the base layer comprising stiffening elements 20, 61 described above. The tyre comprises a tread 126 applied to the middle wall 72 of the base layer. In some examples the tread may extend along the side walls 74 and 78 of the tyre base layer. An injection molding apparatus is used to add tyre tread to the tyre base layer comprising stiffening elements 20, 61. The injection molding apparatus comprises a tread mold into which the tyre base layer comprising stiffening elements 20, 61 is placed. The tyre base layer comprising stiffening elements 20, 61 is positioned within the tread mold for overmolding to take place. An elastomer is injection molded on to the tyre base layer comprising stiffening elements 20, 61 in order to overmold the tread onto the tyre base layer comprising stiffening elements 20, 61. In examples where the tyre base layer is formed from a sheet of fabric or mesh fabric the injection molded material will penetrate through the tyre base layer and thus extend from one face of the tyre base layer to the opposite face of the tyre base layer.

Whether provided as belt of continuous tyre base layer (on a spool or otherwise), or provided as a cut-to-size section of tyre base layer comprising stiffening elements, and/or whether provided flat, or provided pre-shaped as discussed above, the tyre base layer comprising stiffening elements can be further processed to add a tyre tread using overmolding, an example of which is provide below.

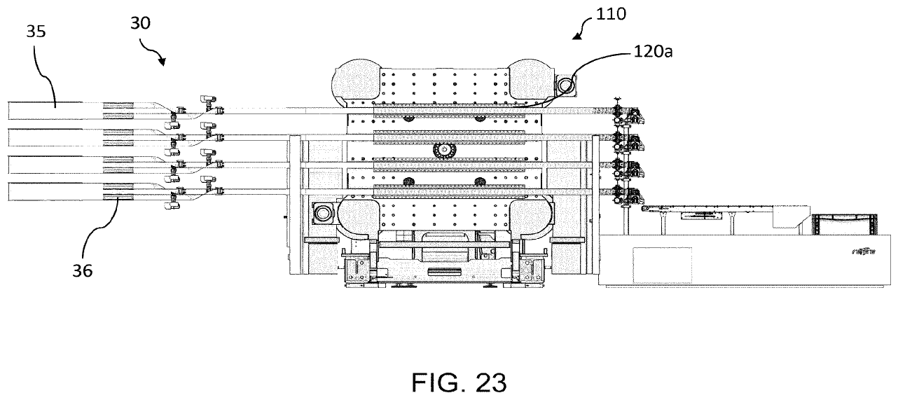

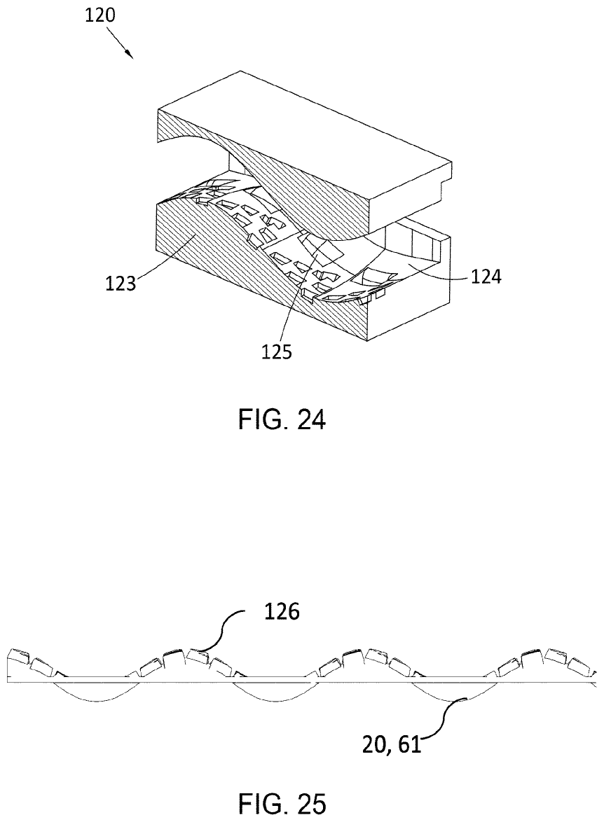

In FIG. 23, an injection molding apparatus 110 is shown which directly receives tyre base layer comprising stiffening elements 20, 61 in the form of a continuous belt of tyre base layer directly from the folding apparatus 30. The cavity of the tread mold 120 may have the substantially flat shape described above in relation to the tyre base layer mold and with reference to FIGS. 18 to 20. A substantially flat tread mold is shown below with reference to FIG. 24. A lower half 120a of the substantially flat tread mold 120 is provided on a stationary part of the injection molding apparatus 110 and an upper half 120b of the substantially flat tread mold 120 is provided on a part of the injection molding apparatus moveable relative to the stationary part. As the halves of the tread mold 120 are separated the continuous belt of tyre base layer is fed from the folding apparatus 30 and aligned with the lower half of the tread mold 120a. The upper half 120b of the tread mold is moved in order to close the mold 120 and a thermoplastic injected into the cavity of the mold. Once the injected thermoplastic has set and adopted the shape of the cavity of the tread mold, the upper half of the tread mold 120b is moved away from the lower half 120a and the continuous belt of tyre base layer and overmolded tread is drawn from the tread mold. Simultaneously with the movement of the continuous belt of tyre base layer and overmolded tread, further tyre base layer comprising stiffening elements comprised in the continuous belt is drawn into the injection molding apparatus 110 from the folding apparatus 30.

The continuous belt of tyre base layer can instead be fed into the injection molding apparatus 110 from a spool.

FIG. 24 shows a section of the substantially flat tread mold 120 which comprises a tread pattern 125 on the cavity wall 124 of the lower piece 123.

FIG. 25 shows tyre base layer with stiffening elements 20, 61 plus an overmolded tyre tread 126 having the substantially flat shape. The substantially flat shape of the combined tread 126 and tyre base layer comprising stiffening elements 20, 61 is a result of the overmolding step, that is, a flat belt of tyre base layer can be inserted into the tread mold 120 and the application of the elastomer to form the tread 126 combined with the application of heat and pressure during the overmolding process causes the tyre base layer comprising stiffening elements 20, 61 to adopt a shape comprising the depressions and elevations of the substantially flat tread mold 120. In other examples, the tyre base layer comprising stiffening elements is pre-shaped before entering the substantially flat tread mold 120 and the shape of the tyre base layer and tread following overmolding may be a contribution of the tread molding process and the pre-shaping.

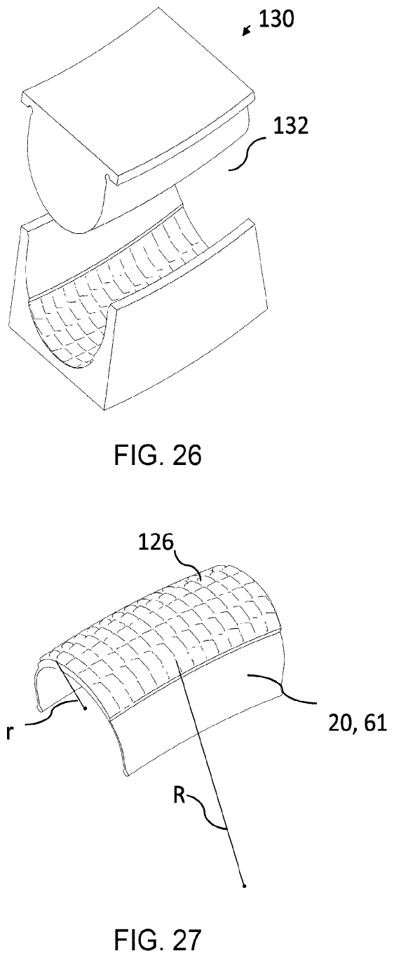

FIG. 26 shows a segment tread mold 130 comprising a cavity 132 shaped as a segment of a double curved tyre shape. FIG. 27 shows the tyre base layer comprising stiffening elements 20, 61 plus an overmolded tread 126 formed using the segment tread mold 130 which comprises the double curved tyre shape of radius r and R described above. The double curved tyre shape of the combined overmolded tread 126 and tyre base layer 20, 61 may be a result of the application of the elastomer to form the tread 126 combined with the application of heat and pressure during the overmolding process. Pre-shaped tyre base layer comprising stiffening elements 20, 61 can be inserted into the segment mold 130, the shaping of which can contribute to the final shape of the combined tread 126 and tyre base layer comprising stiffening elements 20, 61.

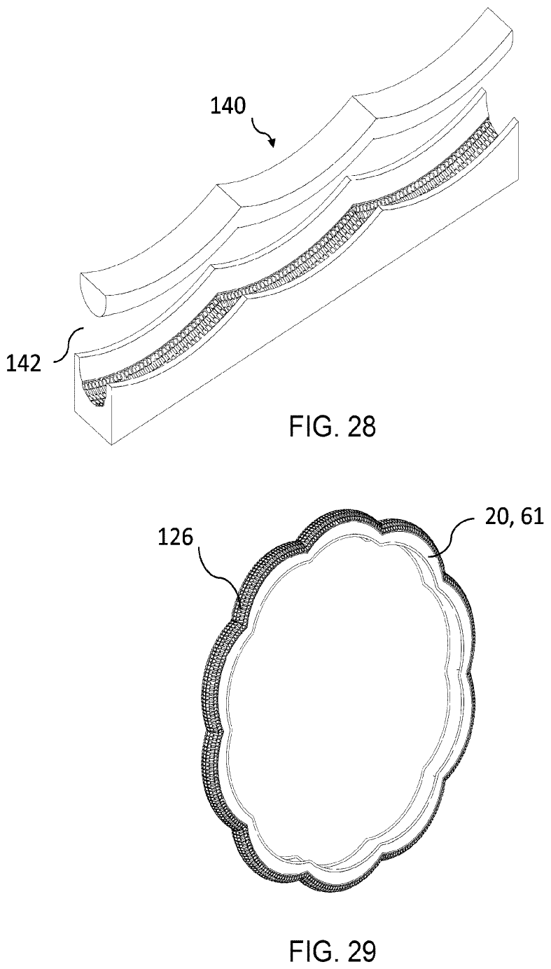

FIG. 28 shows a tread mold 140 comprising a cavity 142 shaped as a plurality of segments of a double curved tyre shape. FIG. 29 shows a resulting tyre base layer comprising stiffening elements 20, 61 plus an overmolded tread 126. The joins between adjacent segments of the base layer and overmolded tread have been manipulated (e.g. bent or stretched) compared to the shape of the cavity of the tread mold 140 in order to form a continuous curvature. The shape shown in FIG. 29 can be further manipulated into a circular tyre shape if required.

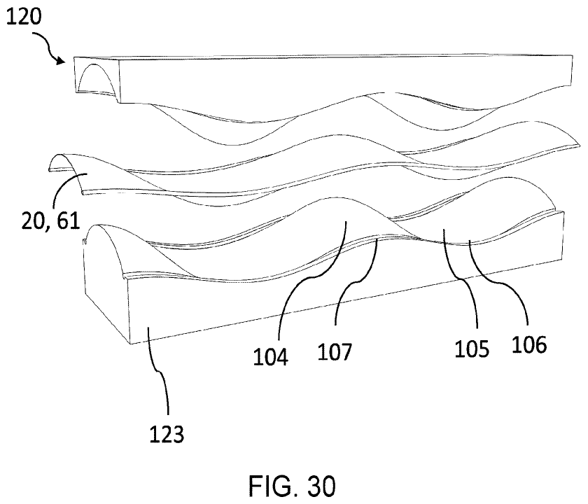

The tyre base layer comprising stiffening elements 20, 61 can be pre-shaped as described above, and the tread subsequently overmolded on to the pre-shaped tyre base layer. In some examples, dimensions of the tyre base layer are larger than the dimensions of the tread mold. As shown in FIG. 30, when the tyre base layer comprising stiffening elements 20, 61 is pre-shaped to comprise a substantially flat shape, the amplitude and wavelength of the depressions and elevations is larger than the equivalent amplitude and wavelength of the substantially flat tread mold 120. That is, the change in height between the low point 107 and the peak 104, the high point 106 and the trough 105 and the distance between the peak 104 and trough 105 of the tread mold 120 are smaller than those distances of the pre-shaped tyre base layer. The tread pattern 125 of the tread mold 120 of FIG. 30 has been omitted for clarity.

The relative differences in the amplitude and wavelength of the depressions and elevations between the pre-shaped tyre base layer and the tread mold differ depending on the thermal expansion properties of the tyre base layer and the elastomer of the tread. In some cases, the amplitude and wavelength of the depressions and elevations is larger of the substantially flat tread mold 120 than the equivalent amplitude and wavelength of the pre-shaped tyre base layer. Alternatively, some dimensions may be larger in the substantially flat tread mold while some dimensions are smaller compared to the pre-shaped tyre base layer.

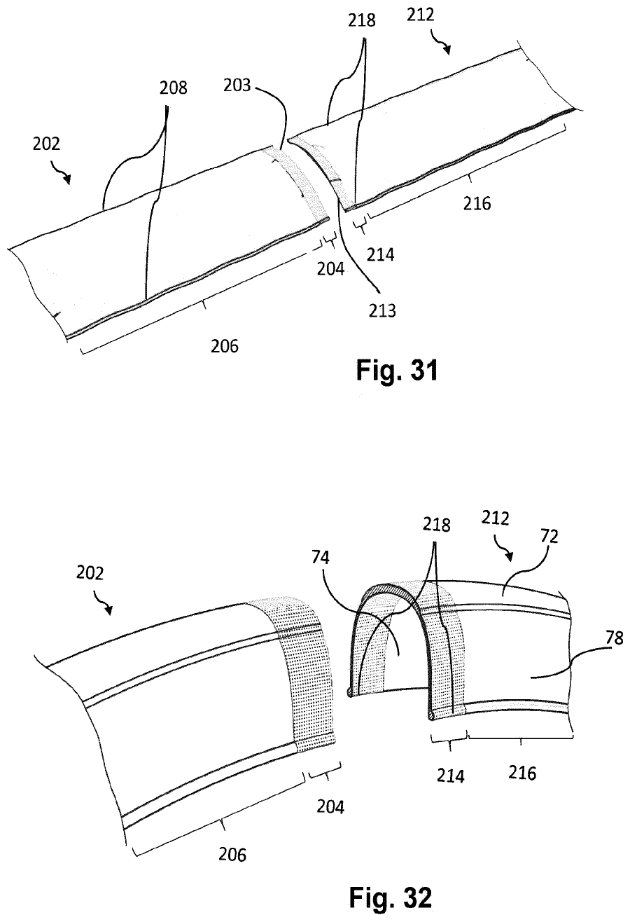

FIG. 31 shows a first length of tyre base layer 202 and a second length of tyre base layer 212. The first length of tyre base layer 202 comprises a first end portion 204, a first main portion 206, and a first pair of stiffening elements 208. The second length of tyre base layer 212 comprises a second end portion 214, a second main portion 216, and a second pair of stiffening elements 218. The first and second tyre base layer end portions 202, 212 are aligned as shown and joined in order that the stiffening elements of the first and second pairs of stiffening elements 208, 218 align.

The first and second lengths of tyre base layer may be flat as shown in FIG. 31. The first and second lengths of tyre base layer may instead be pre-shaped in order to comprise a curve. As shown in FIG. 32, the first and second lengths of tyre base layer may be pre-shaped in order to have a double curved shape, i.e. comprises a curvature having a radius of curvature r in a lateral cross section and a curvature having a radius of curvature R in a cross section perpendicular to the longitudinal cross section of the cylindrical tyre. The double curved tyre shape can also be described as an annular segment having an omega “(” cross section. The base layers will then have first and second side walls 74, 78 and middle wall 72 as described above.

The first and second lengths of tyre base layer 202, 212 can be produced in a known way.

The first and second lengths of tyre base layer 202, 212 can be made using any steps of the method described above for manufacturing a continuous belt of tyre base layer. Prior to the joining operation the continuous belt of tyre base layer can be cut into the first and second lengths of tyre base layer separate to one another and each having a predetermined length. Alternatively, prior to the joining operation the continuous belt of tyre base layer can be cut into a single piece of predetermined length and the first.

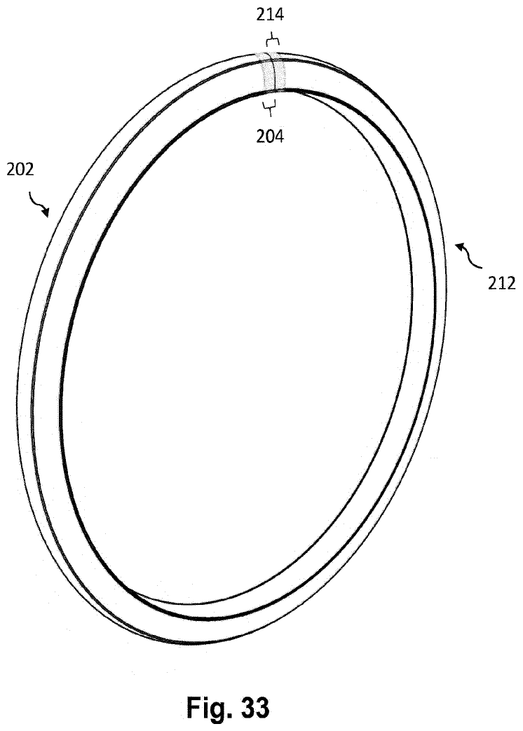

The first and second lengths of tyre base layer 202, 212 can be continuous as shown in FIG. 33. That is, the first end portion 204 and the second end portion 214 are disposed at longitudinal ends of a single piece of tyre base layer. Thus, a complete loop of tyre base layer is made requiring a single join.

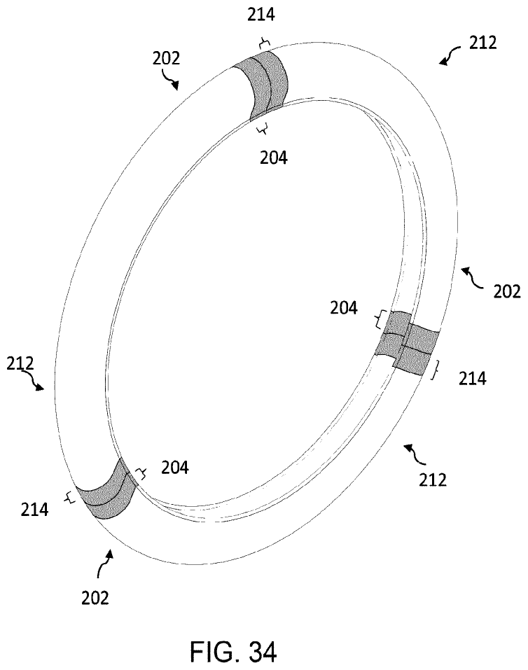

In other examples, multiple joins are required to form a complete loop of base layer suitable for use in a tyre. As shown in FIG. 34 where the first length of tyre base layer 202 of one join also provides the second length of tyre base layer 212 for another join.

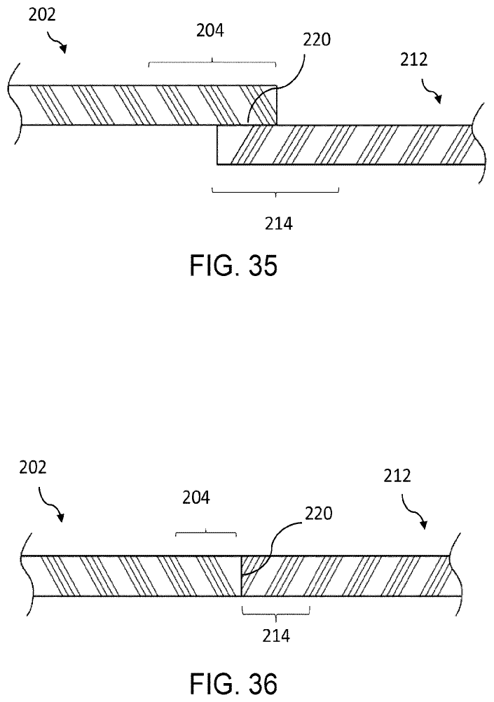

A region of contact 220 is made between the first and second end portions 204, 214. This is shown in FIGS. 35 and 36. In FIG. 35 the region of contact 220 is formed by overlapping the first end portion 204 with the second end portion 214 to form a double thickness of tyre base layer in the region of contact 220. In FIG. 36, the region of contact 220 is formed by abutting a longitudinal face of the first length of base layer 203 (shown in FIG. 31) with a longitudinal face of the second length of base layer 213 (shown in FIG. 31).

A welding operation can then be performed in the region of contact to secure the first and second lengths of tyre base layer 202, 212 to one another. The first and second lengths of tyre base layer 202, 212 can be secured additionally or alternatively by providing a glue or adhesive material between the first and second lengths of tyre base layer 202, 212 in the region of contact.

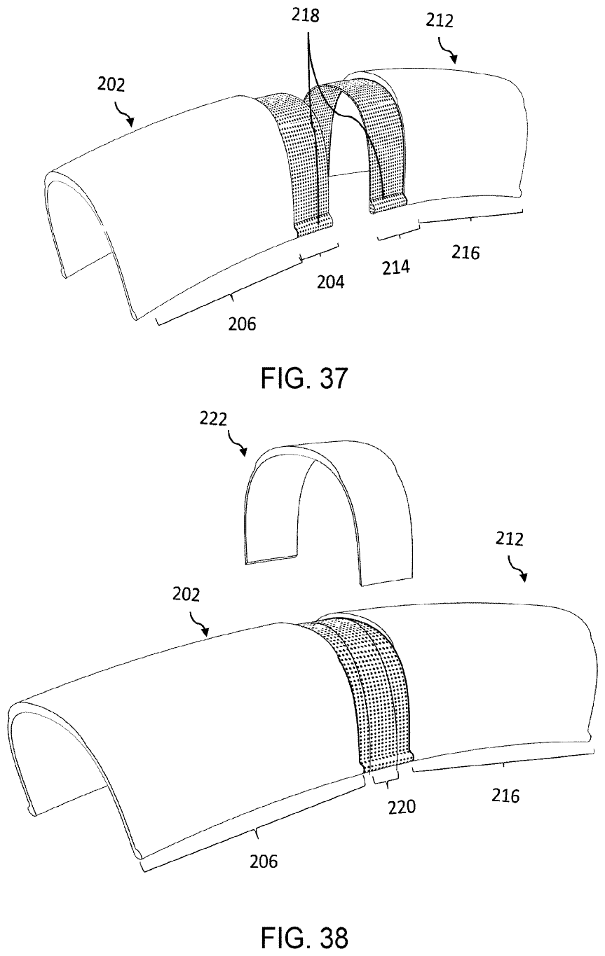

In FIG. 37, an example is shown wherein the first and second end portions 204, 214 comprise only a mesh fabric, whereas the first and second main portions 206, 216 comprise a mesh fabric and an elastomer. A region of contact 220 (shown in FIG. 38) will be made between at least a portion of the first end portion 206 and at least a portion of the second end portion 216 by at least partly overlapping the two end portions 204, 214. The joining of the two end portions 204, 214 can then be performed by overmolding an elastomer over the first end portion 204, the region of contact 220 and the second end portion 214. The piece 222 represents the overmolded piece that will added to the joined baselayer once the overmolding process is carried out. The piece 222 will thus extend from and join the first main portion 206 to the second main portion 216. By ensuring the end of the region of contact 220 and the join of the overmolded elastomer to the first and second main portions 206, 216 are misaligned, a stronger join can be made by avoiding weak points from each join being aligned. However, it is adequate results can be achieved by completely overlapping the first and second end portions 214, 204 to form the contact region 220. Since the mesh fabric has an open structure, the elastomer can infiltrate the mesh fabric to create a strong join by improving both the mechanical bonding between the first and second base layers as well as the chemical bonding between the elastomer and the fibres. Similar advantages can be realised using this process with other base layer materials comprising fibres.

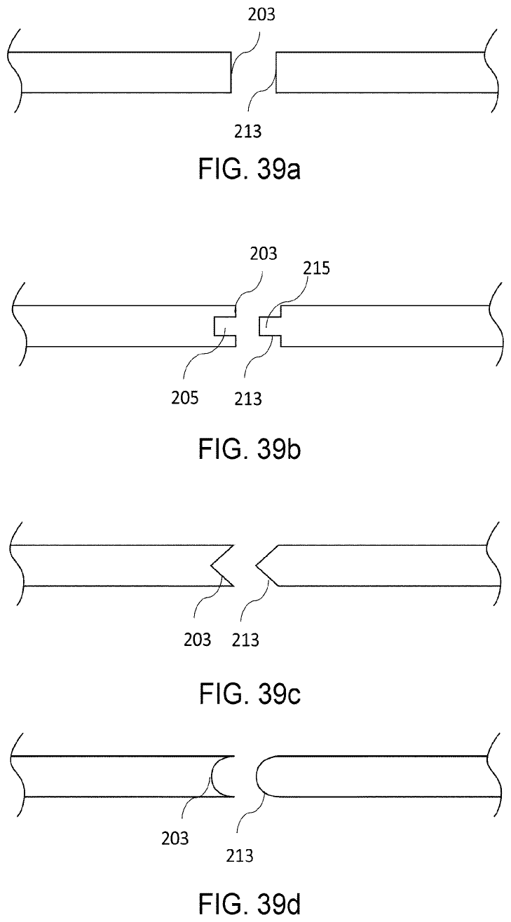

In particular, when the region of contact 220 is created by abutting longitudinal end faces of the first and second lengths of base layer 203, 213, the end faces 203, 213 can have complementary shapes as shown in FIGS. 39a to 39d so that the faces interlock when joined. In FIG. 39a, the end faces 203, 213 each have a straight shape oriented perpendicular to the longitudinal length of the respective first and second length of tyre base layer. In FIG. 39b the end faces have a plurality of lengths perpendicular to the length of the tyre base layer, the plurality of lengths form a stepped shape which provides more surface area of contact between the end faces. The longitudinal end face of the first length of tyre base layer 203 has such a stepped shape to also have an indent 205 and the longitudinal end face of the second length of tyre base layer 213 has such a stepped shape to also have a protrusion 215. The protrusion 215 fits within the indent 205. In FIG. 39c the longitudinal end face of the second length of tyre base layer 213 has an extending chevron shape, and the longitudinal end face of the first length of tyre base layer 203 has a cut-away chevron shape. The chevrons are formed of a plurality of lengths non-perpendicular to the longitudinal length of the tyre base layer. In FIG. 39d the longitudinal end face of the second length of tyre base layer 213 has a convex curved shape, and the longitudinal end face of the first length of tyre base layer 203 has a concave curved shape.

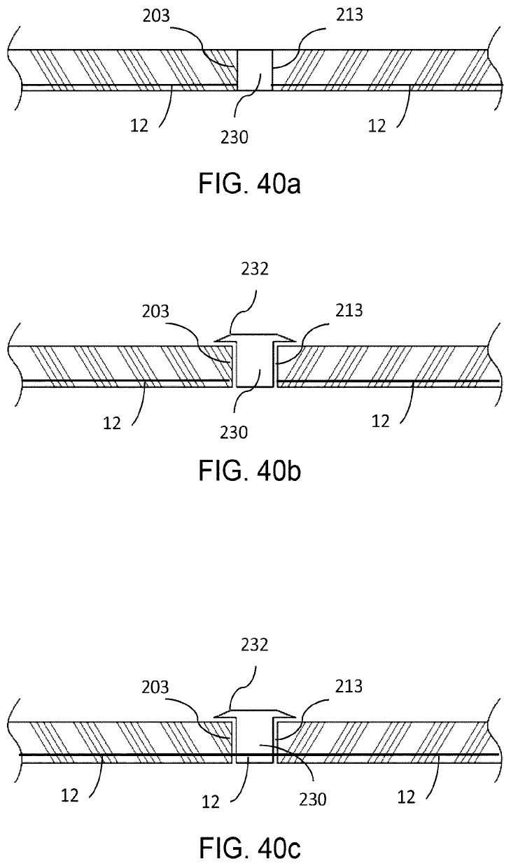

An insert 230 can be placed between the first and second lengths of tyre base layer 202, 212. The insert 230 shown in FIG. 40a is positioned between the end faces 203, 213. The stiffening elements 12 of the first and second lengths of tyre base layer 203, 213 align once joined. The insert is secured to each of the end faces 203, 213 in order to secure the first and second lengths of tyre base layer 202, 212 to one another. FIG. 40b shows an insert 230 comprising an insert head portion 232 that protrudes above the first and second lengths of tyre base layer 202, 212 and that extends laterally and longitudinally over the first and second lengths of tyre base layer 202, 212, extending over the end portions 204, 214 and/or main portions 206, 216.

In FIG. 40c an example is shown in which the pair of stiffening elements 12 extend through the insert 230 so that connection can be made between the first and second pairs of the stiffening elements in the first and second length of tyre base layer respectively.

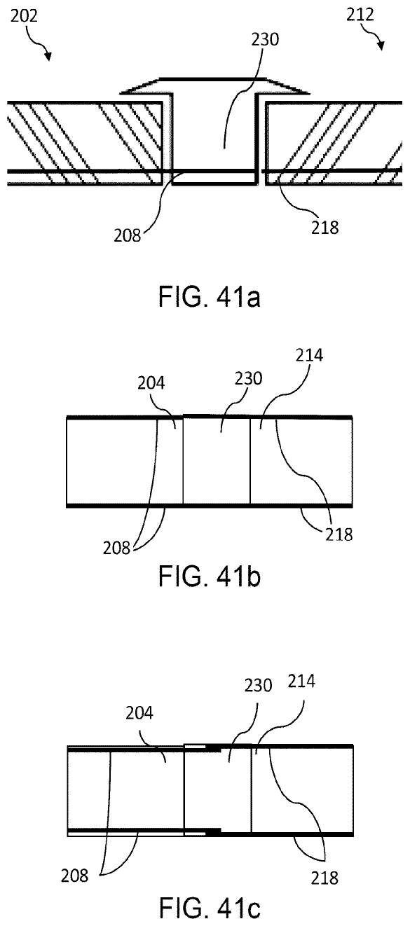

FIG. 41a shows an expanded view of the join, i.e. before contact is made and the join completed. FIG. 41a shows stiffening elements 208 of the first length of tyre base layer 202 extending from the first end portion 204. The first pair of stiffening elements 208 overlap the second pair of stiffening elements 218 in the longitudinal direction, hence the tips of the pairs of stiffening elements will abut one another once the join is made. The tips can then be joined via welding, soldering, sewing or an adhesive. For example, the sewing of aramid stiffening elements may be executed with an aramid thread. FIG. 41b shows this situation in plan view. FIG. 41c shows a similar example with both the first and second pairs of stiffening elements 208, 218 extending from the first and second end portions 204, 214 respectively, however the stiffening elements overlap in a lateral direction.

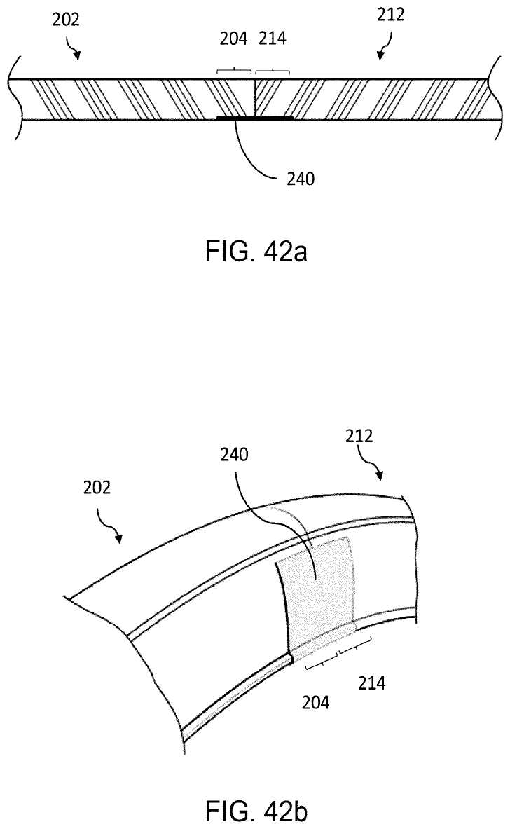

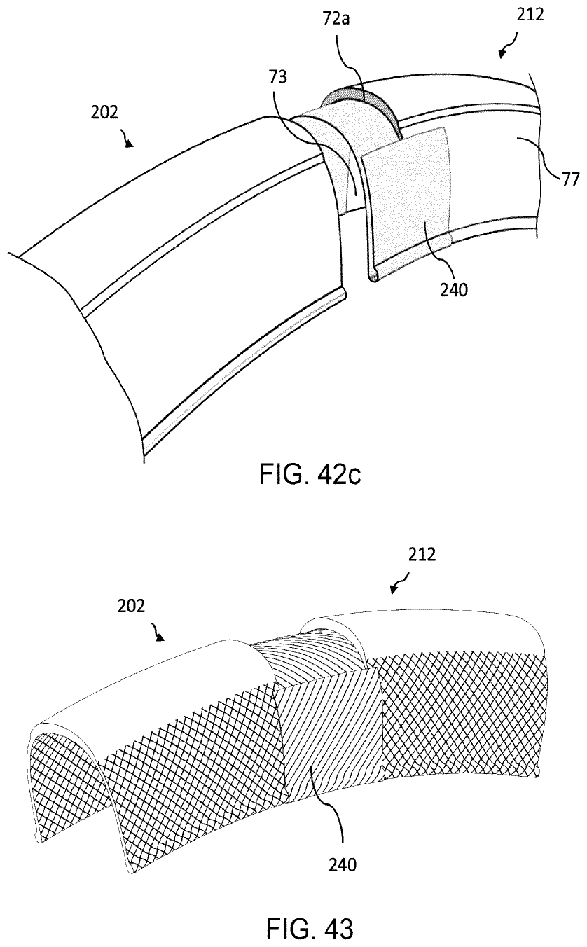

FIG. 42a shows a join between the first and second lengths of tyre base layer 202, 212 that comprises a liner material 240 bonded to the first and second end portions 204, 214.

FIG. 42b shows an example wherein the first and second lengths of tyre base layer 202, 212 are shaped with a double curved shape. FIG. 42c shows an expanded view of FIG. 42b (i.e. without the contact and join having been made) which shows the position and extent of the liner material 240 about the join. The liner material 240 extends from a radially outer surface (not shown) of the first side wall 74 relative the radius of curvature r, to the radially inner surface 73 of the first side wall 74 relative the radius of curvature r, along the radially inner surface 72a of the middle wall 72 relative the radius of curvature r, along the radially inner surface (not shown) of the second side wall 78 and to the outer surface 77 of the second side wall 78.

The liner 240 can extend around the entire join and can be considered to be a sleeve. The sleeve 240 can be tight enough, and/or comprise an adhesive, sufficient to secure the first and second lengths of tyre base layer 202, 212 to one another. In some examples the liner 240 comprises fibres providing additional strength.

FIG. 43 shows an example wherein the liner 240, first length of tyre base layer 202 and second length of tyre base layer 212 comprise fibres. A fibre direction of each component is indicated in the figure by the direction of the cross hatching. The fibre direction of the liner 240 substantially aligns with a fibre direction of the first and second length of tyre base layer 202, 212. In some examples the liner 240 additionally or alternatively comprises fibres that extend in the longitudinal direction of the first and second lengths of tyre base layers 202, 212. It will be understood that the liner and/or first and second lengths of tyre base layer can additionally comprise fibres extendnig in alternative directions to those indicated in FIG. 43.

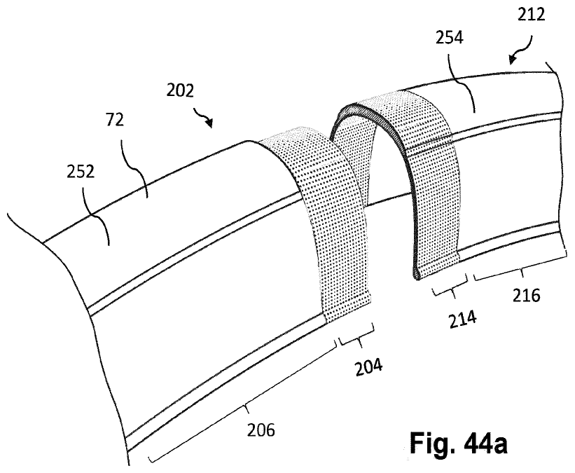

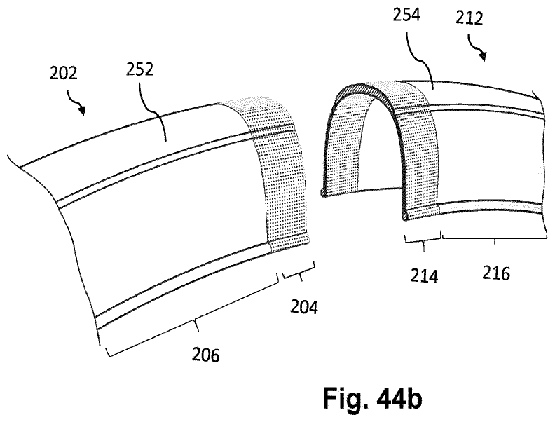

In FIG. 44a, the first length of tyre base layer 202 comprises a first tread portion 252 and the second length of tyre base layer 212 comprises a second tread portion 254. The first tread portion 252 is disposed above the first main portion 206 of the first length of tyre base layer 202 on the middle wall 72, but does not extend over the first end portion 204. The second tread portion 254 is disposed above both the second main portion 216 and the second end portion 214. Once the join is made according to any of the discussion above, the first end portion is disposed beneath (radially inwardly of) the second end portion such that the first tread portion 252 abuts the second tread portion 254.

In FIG. 44b the first tread portion 252 extends over both the first main portion 206 and the first end portion 204, and the second tread portion 254 extends over the second main portion 216 and the second end portion 214. The region of contact 220 is provided by the longitudinal end faces of the first and second lengths of tyre base layer and tread portions so that the first and second lengths of tyre base layer are secured to one another and the first and second tread portions are secured to one another.

In examples where an insert 230 is used the insert can comprise an insert tread portion 234 which may be provided on the insert head portion 232 or in place of the insert head portion 232.

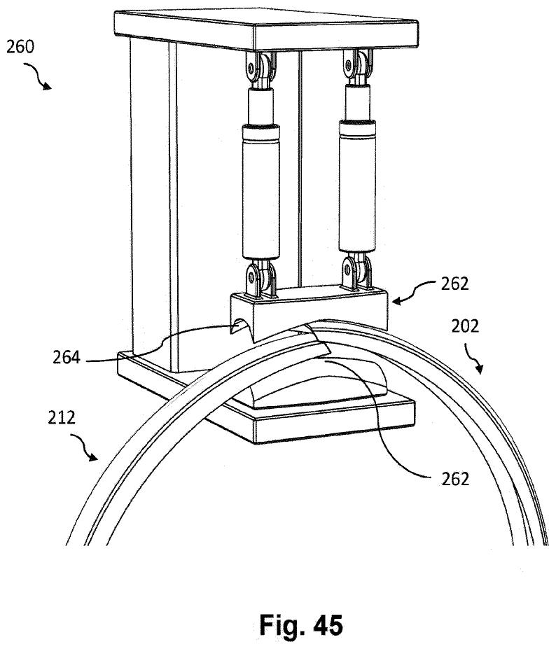

FIG. 45 shows a joining apparatus 260 used to join the first and second lengths of tyre base layer 202, 212. The joining apparatus comprises a clamp 262 for maintaining the first and second lengths of tyre base layer in position so that the end portions 204, 214 can be joined appropriately. The joining apparatus shown in FIG. 45 is configured to apply heat and pressure between a top clamp surface 264 and a bottom clamp surface 266 in order to form the join.

1. A method of manufacturing a continuous belt of tyre base layer, the method comprising:
providing a sheet of material having a first lateral edge portion, and a second lateral edge portion, wherein the first lateral edge portion is separated from the second lateral edge portion by a central portion,
laying a first stiffening element on the sheet where the first lateral edge portion and central portion meet, and laying a second stiffening element on the sheet where the central portion and second lateral edge portion meet,
folding the first lateral edge portion over the first stiffening element,
folding the second lateral edge portion over the second stiffening element, and
securing the first lateral edge portion and the second lateral edge portion to the central portion.

2. A method as claimed in claim 1, wherein the sheet comprises a longitudinal length, the first lateral edge portion and central portion meet along a line parallel to the longitudinal length of the sheet, and the central portion and second lateral edge portion meet along a line parallel to the longitudinal length of the sheet.

3. A method as claimed in claim 1 or 2, wherein following the folding of the first lateral edge portion over the first stiffening element and following the folding of the second lateral edge portion over the second stiffening element, the first lateral edge portion and the second lateral edge portion overlap, and the method comprises:
securing the first lateral edge portion to the second lateral edge portion.

4. A method as claimed in claim 1, 2 or 3, wherein the stiffening element is a bead wire comprising a metal, or a thermoplastic polymer, or a thermoset polymer.

5. A method as claimed in any of claims 1 to 4, wherein the first and/or second stiffening element are secured to the sheet of material.

6. A method as claimed in any preceding claim, wherein the sheet of material comprises fibre and one or more of an elastomer and an epoxy.

7. A method as claimed in any preceding claim, wherein the sheet of material comprises fibres disposed in a weave pattern or a knitted pattern, and wherein the longitudinal length of the fibres in the weave pattern is mis-aligned with the longitudinal direction of the sheet of material.

8. A method as claimed in claim 7, wherein the longitudinal length of the fibres is mis-aligned with the longitudinal direction of the sheet of material by 30 degrees or more.

9. A method as claimed in any preceding claim, wherein the securing comprises welding the overlapped material together using a welding operation.

10. A method as claimed in any preceding claim, wherein the securing comprises adding a bonding material to the overlapped portions of the sheet of material.

11. A method as claimed in any preceding claim, wherein the method comprises providing a puncture protection layer on at least part of the central portion of the sheet of material.

12. A method as claimed in claim 11, wherein the puncture protection layer comprises one or more of elastomer, plastic, composite, fibre sheet, fibre reinforced elastomer.

13. A method as claimed in any preceding claim, comprising spooling the continuous belt of tyre base layer onto a reel.

14. A method of manufacturing a continuous belt of tyre base layer, the method comprising:
providing a tubular material having a longitudinal length,
inserting a first stiffening element and a second stiffening element into the tubular material such that a longitudinal length of each stiffening element is parallel with the longitudinal length of the tubular material,
affixing the first and second stiffening elements to opposite first and second longitudinal sides of the tubular material.

15. A method as claimed in claim 14, wherein providing the tubular material comprises providing a sheet of material having a first longitudinally extending edge portion and a second longitudinally extending edge portion opposite the first edge portion; and
securing the first longitudinally extending edge portion to the second longitudinally extending edge portion to form a tube.

16. A method as claimed claim 15, wherein the first and second stiffening elements are introduced into the tubular material as the first and second edge portions are being secured together.

17. A method as claimed in claim 15 or 16, wherein the securing of the first edge portion to the second edge portion of the sheet of material comprises sewing the first edge portion to the second edge portion.

18. A method as claimed in claim 15 or 16, wherein the securing of the first edge portion to the second edge portion of the tubular material comprises welding, using a welding operation, or sewing the overlapped material together.

19. A method as claimed in claim 15 or 16, wherein the securing of the first edge portion to the second edge portion of the tubular material comprises adding a bonding material to the sheet of material.

20. A method as claimed in any of claims 14 to 19, wherein tubular material between and above the first and second stiffening elements is secured to tubular material between and below the first and second stiffening elements.

21. A method as claimed in any of claims 14 to 20, wherein the tubular material comprises fibres disposed in a weave pattern, and wherein the weave pattern is mis-aligned with the longitudinal length of the tubular material.

22. A method as claimed in claim 21, wherein the longitudinal length of the fibres is mis-aligned with the longitudinal direction of the tubular material by at least 30 degrees. Optionally the fibres may be mis-aligned with the longitudinal direction of the sheet of material by 45 degrees.

23. A method as claimed in any of claims 14 to 22, wherein the method comprises providing a puncture protection layer on or between at least part of the overlapping portion of tubular material.

24. A method as claimed claim 23, wherein the puncture protection layer comprises one or more of elastomer, plastic, composite, fibre sheet, fibre reinforced elastomer.

25. A method as claimed in claim 23 or 24, wherein the puncture protection layer is provided on the radially outer side of the tubular material as viewed in cross section perpendicular to the longitudinal length of the tubular material and/or the puncture protection layer is provided on the radially inner side of the tubular material as viewed in cross section perpendicular to the longitudinal length of the tubular material.

26. A method as claimed in claim 23, 24 or 25 when dependent on claim 15, wherein the puncture protection layer is inserted into the tubular material as the first and second edge portions are secured together.

27. A method of manufacturing a tyre base layer, the method comprising:
providing a continuous belt of tyre base layer according to the method of any preceding claim, and
cutting the belt of tyre base layer to a length suitable for use within a single tyre.

28. A method as claimed in any preceding claim, comprising:
applying heat to the tyre base layer and stretching the tyre base layer over the surface of a wheel, causing the tyre base layer to adopt a curvature.

29. A method as claimed in any of claims 1 to 27, comprising:
inserting a length of the continuous belt of tyre base layer into a cavity of a tyre base layer mould;
applying heat and pressure to the length of tyre base layer within the tyre base layer mould such that length of the continuous belt of tyre base layer adopts
the shape of the cavity of the tyre base layer mould, wherein the shape of the cavity of the tyre base layer mould comprises at least one segment of a cylindrical tyre having at least one curvature, wherein the arc of the segment extends along a longitudinal length of the cavity.

30. A method as claimed in claim 29, wherein the segment of a cylindrical tyre comprises a double curve such that the tyre has a radius r in a lateral cross section and a radius of curvature R in a cross section perpendicular to the longitudinal direction of the cylindrical tyre.

31. A method as claimed in claim 29 or 30, wherein the tyre base layer mold is a substantially flat mold comprising a housing comprising at least one longitudinal inner cavity extending between at least two opposing main walls and two opposing edge walls, wherein:
each of the main walls has at least one elevation and at least one depression;
each elevation and each depression extends and slopes in both a lateral and a longitudinal direction of the cavity;
the elevations and depressions are arranged alternately along the length of the tyre base layer mold; and
an elevation of one main wall is opposite a depression of the other main wall.

32. A continuous belt of tyre base layer manufactured according to the method of any preceding claim.

33. A method of manufacturing a tyre base layer and tread element, the method comprising:
providing a continuous belt of tyre base layer according to the method of any preceding claim;
inserting a length of the tyre base layer into a tread mold;
injecting an elastomeric material into the tread mold;
allowing the elastomeric material to set in order that the elastomeric material and tyre base layer adopt the shape of the tread mold; and
removing the bonded tyre base layer and elastomeric material from the tread mold.

34. A method as claimed in claim 33, wherein the shape of a cavity of the tread mould comprises at least one segment of a cylindrical tyre comprising at least one radius of curvature.

35. A method as claimed in claim 34, wherein the continuous belt of tyre base layer is provided according to any of claims 28 to 31 and the radius of curvature adopted by the tyre base layer is larger than the radius of curvature of cavity of the tread mould.

36. A method as claimed in claim 34, wherein the continuous belt of tyre base layer is provided according to claim 31, wherein the dimensions of the depressions and elevations of the tyre base layer mold are greater than the dimensions of the depressions and elevations of the tread mould.

37. A method of manufacturing a tyre; the method comprising:
providing at least one length of tyre base layer and tread element according the method of any of claims 33 to 36,
joining the ends of the at least one length of tyre base layer and tread element to form a complete loop.

38. An apparatus for manufacturing a continuous belt of tyre base layer, the apparatus comprising:
a tyre base layer material spool for storing a sheet of material;
one or more stiffening element spools for storing stiffening elements; and
an assembly unit for receiving material from the tyre base layer material spool and first and second stiffening elements from the one or more stiffening element spools, and for assembling the continuous tyre base layer, wherein the assembly unit comprises a folding apparatus for folding a first edge portion of the sheet of material over the first stiffening element and for folding a second edge portion over the second stiffening element.

39. An apparatus as claimed in claim 38, comprising a securing unit for securing the first and second edge portions to a central portion of the sheet of material.

40. An apparatus as claimed in claim 38 or 39, comprising a spool for storing puncture protection material and means for feeding the puncture protection material to the assembly unit.

41. An apparatus as claimed in claim 38, 39 or 40, wherein the folding apparatus comprises a sewing machine for sewing the first and second stiffening elements into their respective positions on the sheet of material.
